(19) United States
(12) Patent Application Publication
(10) Pub. No.: US 2022/0053436 A1
(43) Pub. Date: Feb. 17, 2022

(54) TRANSMIT AND RECEIVE TIMING ERRORS ESTIMATION AND COMPENSATION

(71) Applicants: Sergey Sosnin, Zavolzhie (RU); Artyom Lomayev, Nizhny Novgorod (RU); Alexey Khoryaev, Nizhny Novgorod (RU)

(72) Inventors: Sergey Sosnin, Zavolzhie (RU); Artyom Lomayev, Nizhny Novgorod (RU); Alexey Khoryaev, Nizhny Novgorod (RU)

(21) Appl. No.: 17/501,276

(22) Filed: Oct. 14, 2021

Related U.S. Application Data
(60) Provisional application No. 63/092,383, filed on Oct. 15, 2020.
(60) Provisional application No. 63/170,938, filed on Apr. 5, 2021.

(51) Int. Cl. H04W 56/00; H04W 24/10

(52) U.S. Cl. CPC H04W 56/005; H04W 56/001; H04W 56/007; H04W 24/10

(57) ABSTRACT

An apparatus of an LMF node includes processing circuitry coupled to a memory. To configure the LMF node for UE location determination in a 5G NR network, the processing circuitry is to decode a measurement report message from a first Next Generation Node-B (gNBi). The measurement report message indicates a time difference (Δtij) between an actual measured propagation time delay (tij) and a reference propagation time delay (Tij) between the gNBi and at least a second gNB (gNBj). The processing circuitry further performs an estimation of a UE location based on the measurement response and adjusts the estimation based on the time difference.

### PRIORITY CLAIM

This application claims the benefit of priority under 35 U.S.C. 119(e) to the following patent applications:

U.S. Provisional Patent Application 63/092,383, filed Oct. 15, 2020, and entitled “TRANSMIT AND RECEIVE TIMING ERRORS ESTIMATION AND COMPENSATION,” which patent application is incorporated herein by reference in its entirety; and

U.S. Provisional Patent Application 63/170,938, filed Apr. 5, 2021, and entitled “MULTI-TEG TRANSMIT AND RECEIVE TIMING ERRORS CALIBRATION USING REFERENCE DEVICE,” which patent application is incorporated herein by reference in its entirety.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, (MulteFire, LTE-U), and fifth-generation (5G) networks including 5G new radio (NR) (or 5G-NR) networks, 5G-LTE networks such as 5G NR unlicensed spectrum (NR-U) networks and other unlicensed networks including Wi-Fi, CBRS (OnGo), etc. Other aspects are directed to techniques for transmit (Tx) and receive (Rx) timing error estimation as well as multi-timing error group (TEG) Tx and Rx timing errors calibration using a reference device in wireless networks, such as 5G-NR networks including 5G non-terrestrial networks (NTNs).

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. Further enhanced operation of LTE and NR systems in the licensed, as well as unlicensed spectrum, is expected in future releases and 5G systems. Such enhanced operations can include techniques for Tx and Rx timing error estimation as well as multi-TEG Tx and Rx timing errors calibration using a reference device in wireless networks.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2, FIG. 3, and FIG. 4 illustrate various systems, devices, and components that may implement aspects of disclosed embodiments.

FIG. 5 illustrates a non-terrestrial network using a non-transparent payload, according to some embodiments.

FIG. 6 illustrates a non-terrestrial network using a regenerative payload, according to some embodiments.

FIG. 7 illustrates a non-terrestrial network including a networking-RAN architecture with a transparent satellite, according to some embodiments.

FIG. 8 illustrates a non-terrestrial network including a regenerative satellite without inter-satellite links (ISL), according to some embodiments.

FIG. 9 illustrates a non-terrestrial network including a regenerative satellite with ISL, according to some embodiments.

FIG. 10 illustrates network-based TX/RX timing errors estimation, according to some embodiments.

FIG. 11 illustrates an example of user-based TX/RX timing errors estimation, according to some embodiments.

FIG. 12 illustrates an example of timing measurements between a UE and i^{th} gNB/TRP, according to some embodiments.

FIG. 13 illustrates an example of timing measurements between three gNBs/TRPs and Reference Device (RD) with a known location, according to some embodiments.

FIG. 14 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

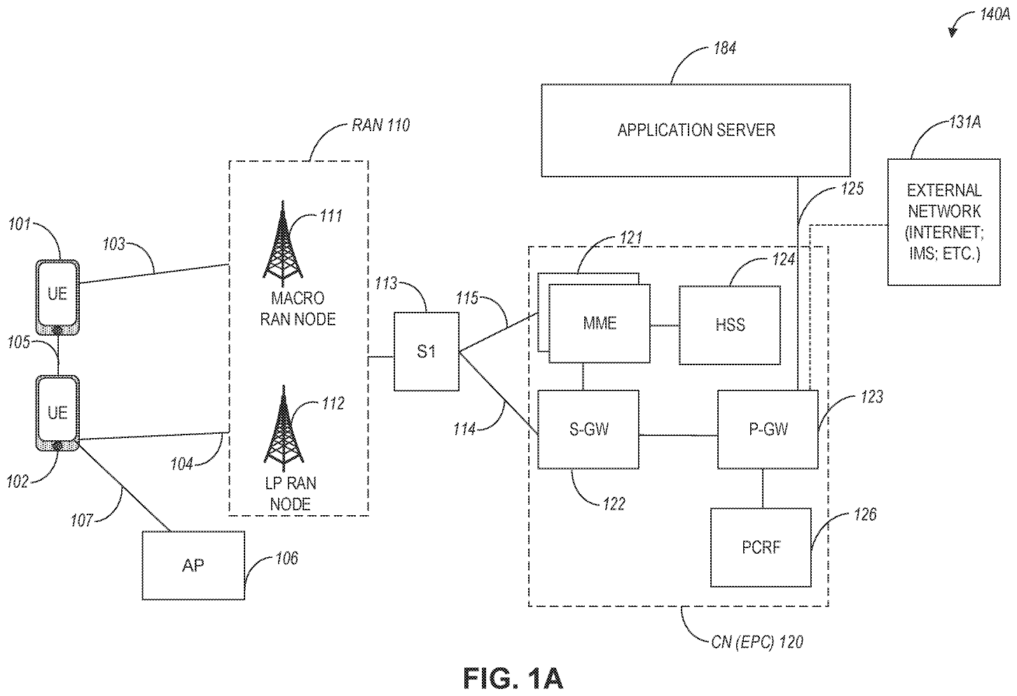

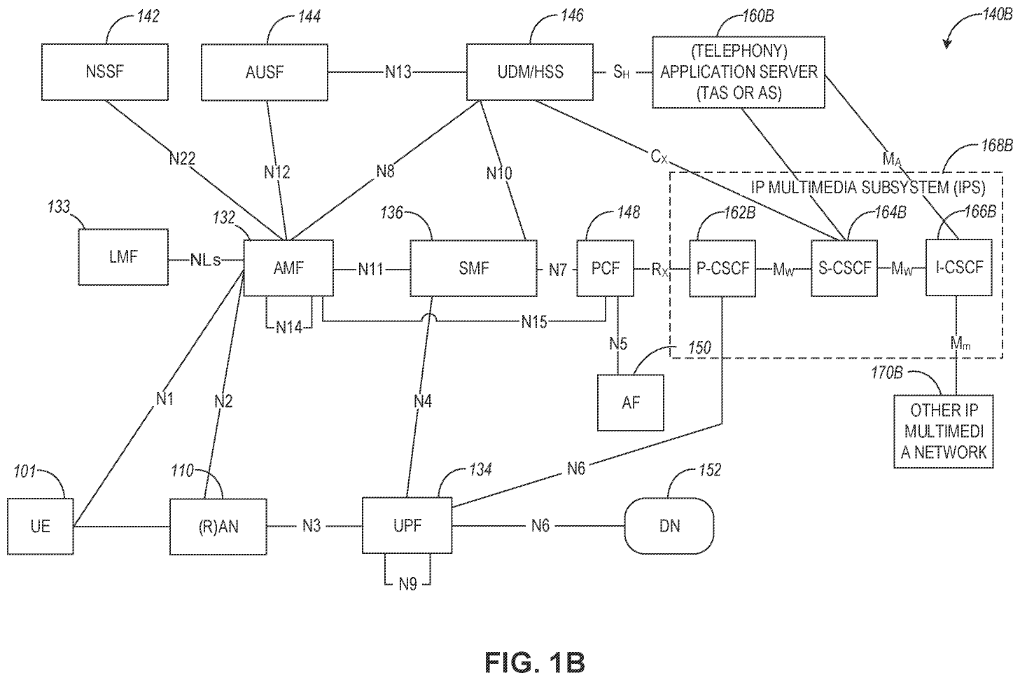

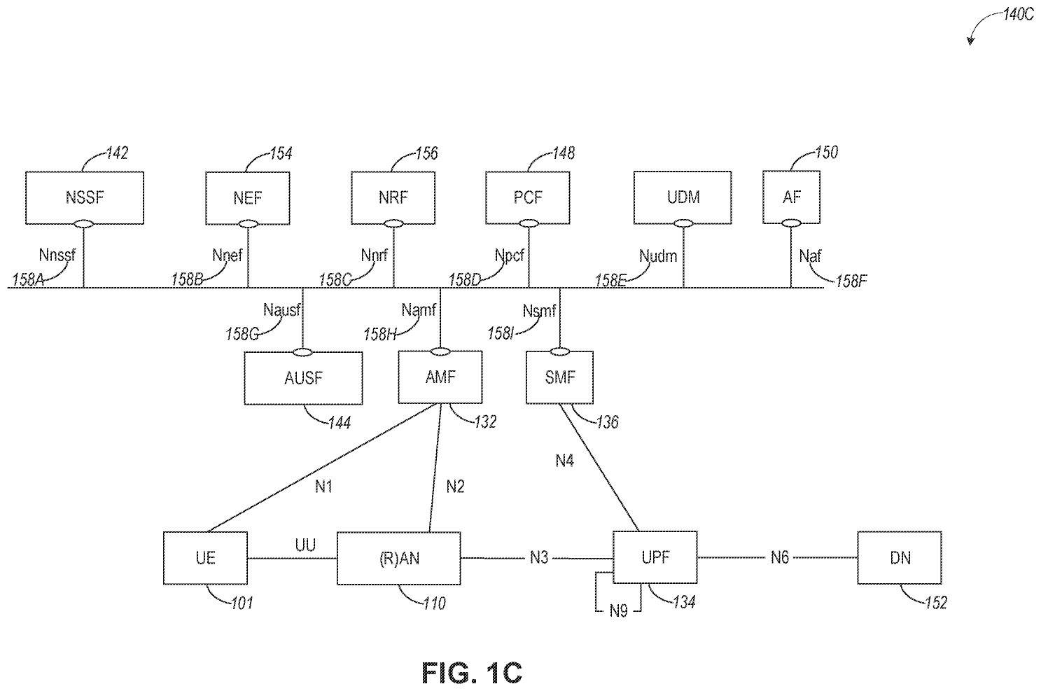

FIG. 1A illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe), or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112 or an unlicensed spectrum based secondary RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries user traffic data between the RAN nodes 111 and 112 and the serving gateway (S-GW) 122, and the S1-mobility management entity (MME) interface 115, which is a signaling interface between the RAN nodes 11 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and route data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN) and NG-eNB can be a secondary node (SN) in a 5G architecture. In some aspects, the master/primary node may operate in a licensed band and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the next generation radio access network (NG-RAN) 110 and the mobile device (e.g., UE 101) via the AMF 132 over the NLs interface to compute the position of the UE 101. In some aspects, NR positioning protocol A (NRPPa) may be used to carry the positioning information between NG-RAN and LMF 133 over a next generation control plane interface (NG-C). In some aspects, LMF 133 configures the UE using the LTE positioning protocol (LPP) via AMF 132. The NG RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

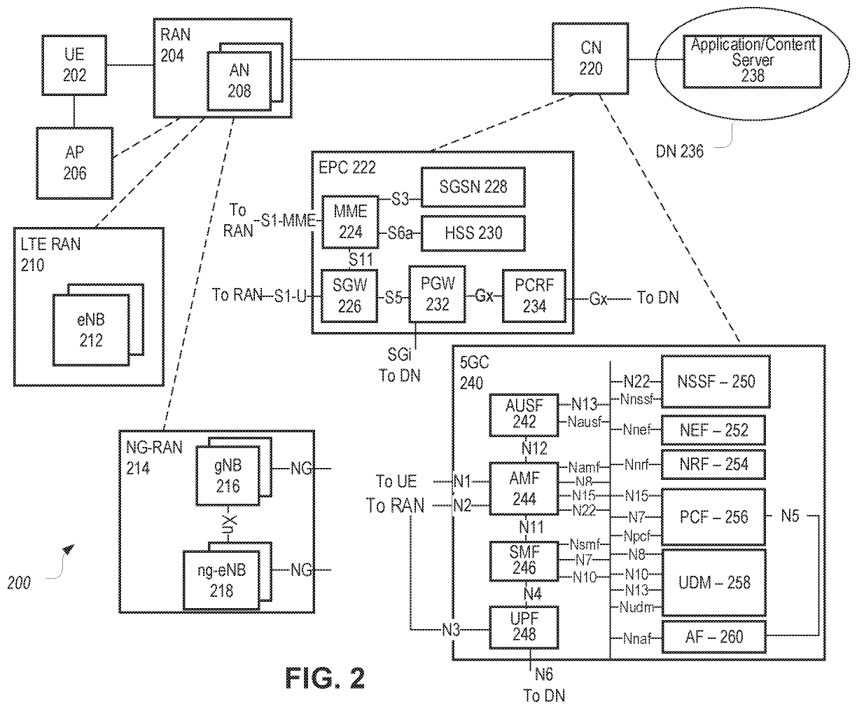

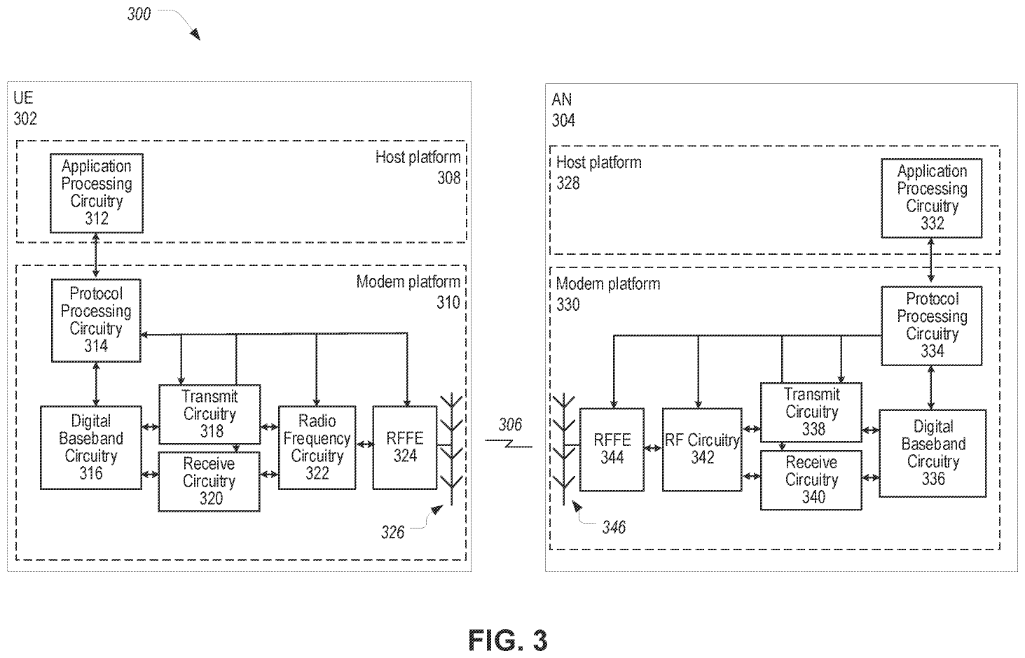

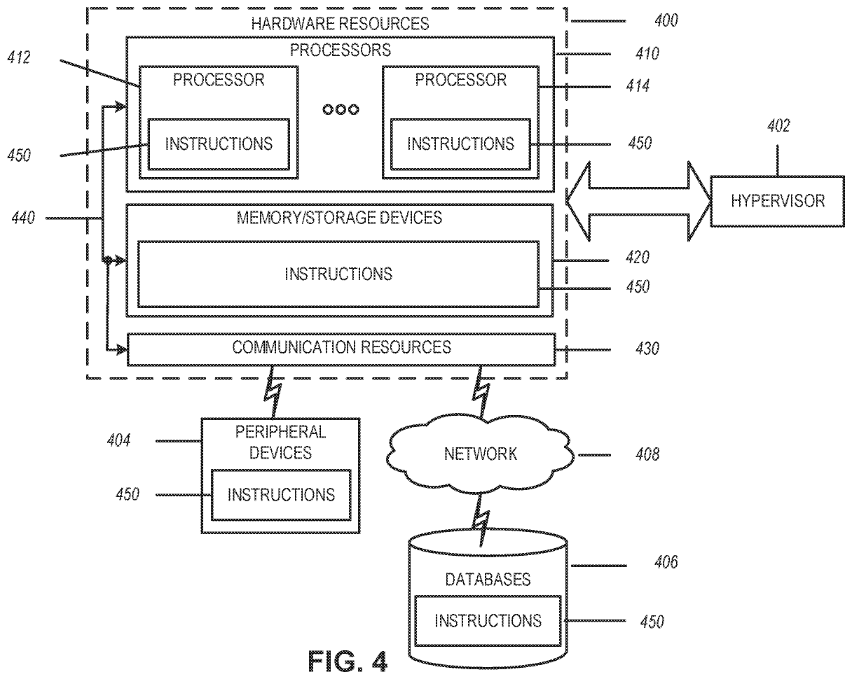

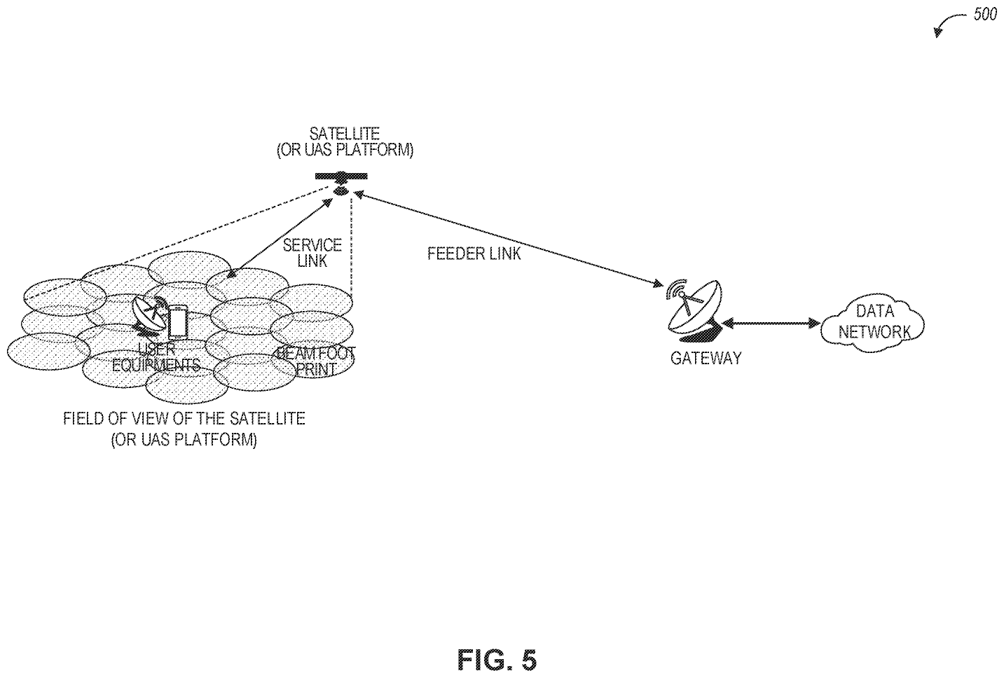

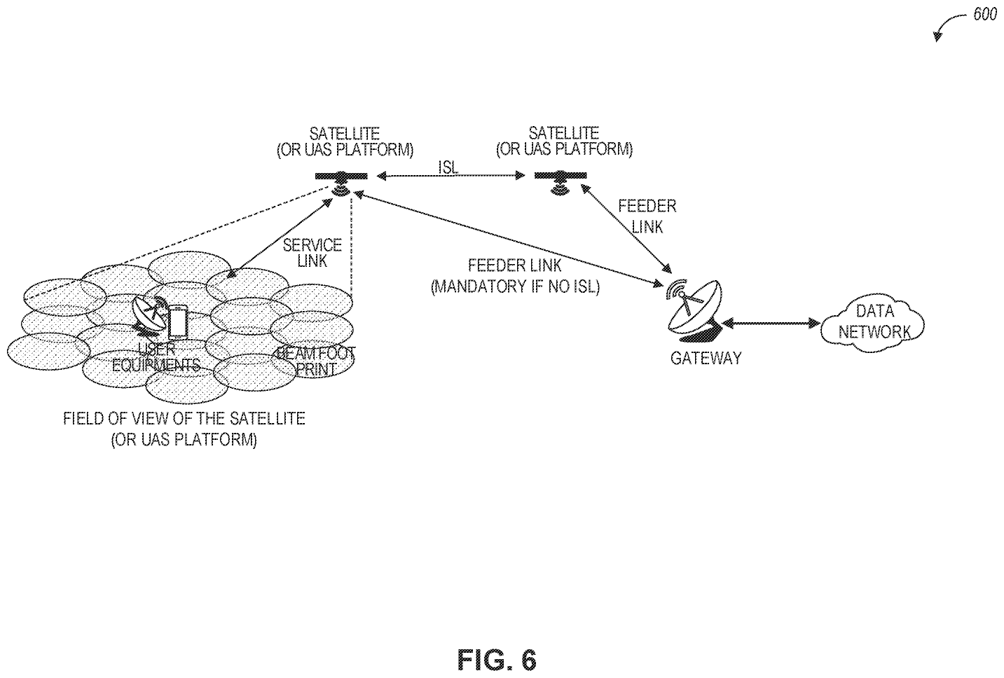

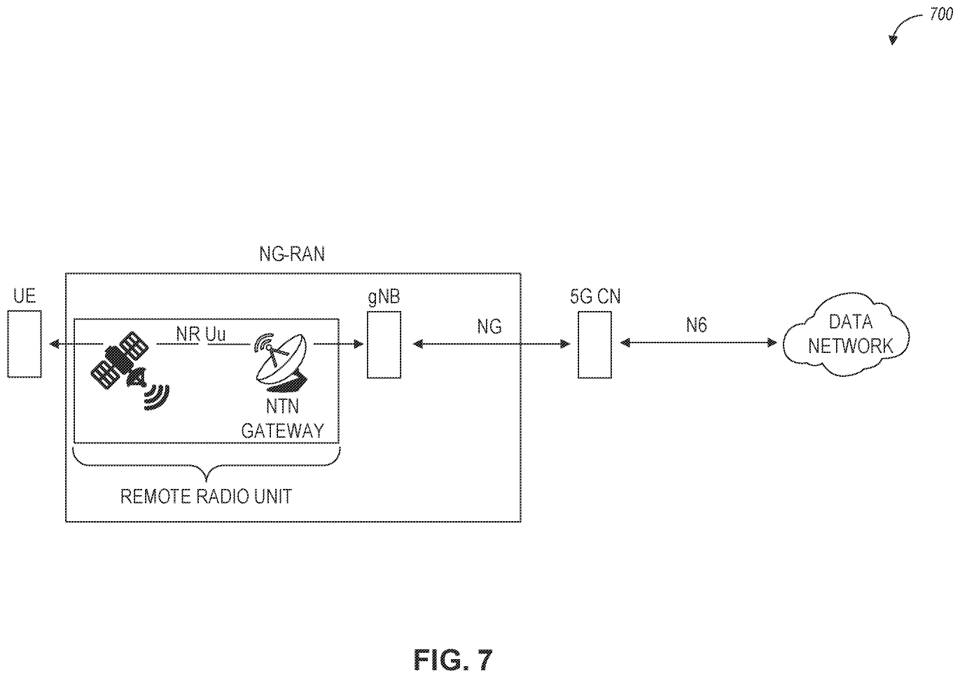

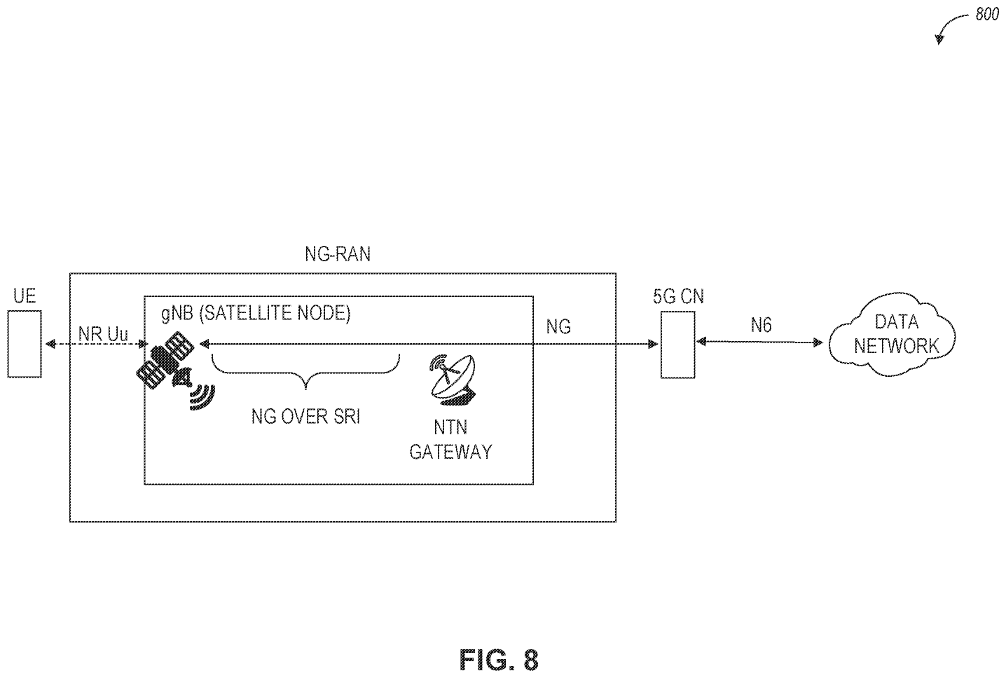

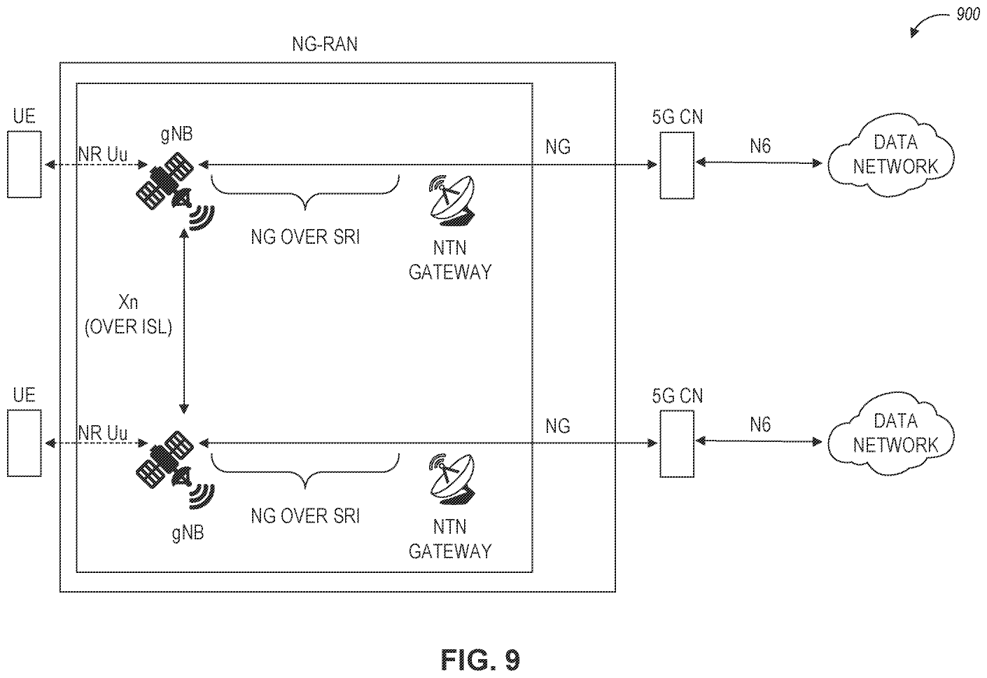

FIG. 2, FIG. 3, FIG. 4, FIG. 5, FIG. 6, FIG. 7, FIG. 8, and FIG. 9 illustrate various systems, devices, and components that may implement aspects of disclosed embodiments in different communication systems, such as 5G-NR networks including 5G non-terrestrial networks (NTNs). UEs, base stations (such as gNBs), and/or other nodes (e.g., satellites or other NTN nodes) discussed in connection with FIGS. 1A-9 can be configured to perform the disclosed techniques.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202, which may include any mobile or non-mobile computing device designed to communicate with a RAN 204 via an over-the-air connection. The UE 202 may be, but is not limited to, a smartphone, tablet computer, wearable computing device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 200 may include a plurality of UEs coupled directly with one another via a sidelink interface. The UEs may be M2M/D2D devices that communicate using physical sidelink channels such as but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 being configured by the RAN 204 to utilize both cellular radio resources and WLAN resources.

The RAN 204 may include one or more access nodes, for example, access node (AN) 208. AN 208 may terminate air-interface protocols for the UE 202 by providing access stratum protocols including RRC, Packet Data Convergence Protocol (PDCP), Radio Link Control (RLC), MAC, and L1 protocols. In this manner, the AN 208 may enable data/voice connectivity between the core network (CN) 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, eNB, ng-eNB, NodeB, RSU, TRxP, TRP, etc. The AN 208 may be a macrocell base station or a low-power base station for providing femtocells, picocells, or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG and a second AN may be a secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/Scells. Before accessing the unlicensed spectrum, the nodes may perform medium/carrier-sensing operations based on, for example, a listen-before-talk (LBT) protocol.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high-speed events, such as crash avoidance, traffic warnings, and the like. Additionally, or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: sub-carrier spacing (SCS) of 15 kHz; CP-OFDM waveform for downlink (DL) and SC-FDMA waveform for uplink (UL); turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface but may connect with a UE via an LTE air interface. The gNB 216 and the ng-eNB 218 may connect over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN 214 and an AMF 244 (e.g., N2 interface).

The NG-RAN 214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS but may use PBCH DMRS for PBCH demodulation; PTRS for phase tracking for PDSCH and tracking reference signal for time tracking. The 5G-NR air interface may operate on FR1 bands that include sub-6 GHz bands or FR2 bands that include bands from 24.25 GHz to 52.6 GHz. The 5G-NR air interface may include a synchronization signal and physical broadcast channel (SS/PBCH) block (SSB) that is an area of a downlink resource grid that includes PSS/SSS/PBCH.

In some embodiments, the 5G-NR air interface may utilize BWPs (bandwidth parts) for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amounts of frequency resources (for example, PRBs) to support data transmission under different traffic loading scenarios. A BWP containing a smaller number of PRBs can be used for data transmission with a small traffic load while allowing power saving at the UE 202 and in some cases at the gNB 216. A BWP containing a larger number of PRBs can be used for scenarios with higher traffic loads.

The RAN 204 is communicatively coupled to CN 220 that includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be connected to the LTE radio network as part of the Enhanced Packet System (EPS) 222, which may also be referred to as an EPC (or enhanced packet core). The EPC 222 may include MME 224, SGW 226, SGSN 228, HSS 230, PGW 232, and PCRF 234 coupled with one another over interfaces (or “reference points”) as shown. Functions of the elements of the EPC 222 may be briefly introduced as follows.

The MME 224 may implement mobility management functions to track the current location of the UE 202 to facilitate paging, bearer activation/deactivation, handovers, gateway selection, authentication, etc.

The SGW 226 may terminate an S1 interface toward the RAN and route data packets between the RAN and the EPC 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track the location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location dependencies, etc. An S6a reference point between the HSS 230 and the MME 224 may enable the transfer of subscription and authentication data for authenticating/authorizing user access to the LTE CN 220.

The PGW 232 may terminate an SGi interface toward a data network (DN) 236 that may include an application/content server 238. The PGW 232 may route data packets between the LTE CN 220 and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for provision of IMS services. The PGW 232 may be coupled with a PCRF 234 via a Gx reference point.

The PCRF 234 is the policy and charging control element of the LTE CN 220. The PCRF 234 may be communicatively coupled to the app/content server 238 to determine appropriate QoS and charging parameters for service flows. The PCRF 234 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for authentication of UE 202 and handle authentication-related functionality. The AUSF 242 may facilitate a common authentication framework for various access types. In addition to communicating with other elements of the 5GC 240 over reference points as shown, the AUSF 242 may exhibit a Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to the management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnecting to data network 236, and a branching point to support multi-homed PDU sessions. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point; and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for the third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on the exposed capabilities of other NFs. This information may be stored at the NEF 252 as structured data, or a data storage NF using standardized interfaces. The stored information can then be re-exposed by the NEF 252 to other NFs and AFs, or used for other purposes such as analytics. Additionally, the NEF 252 may exhibit a Nnef service-based interface.

The NRF 254 may support service discovery functions, receive NF discovery requests from NF instances, and provide the information of the discovered NF instances to the NF instances. NRF 254 also maintains information on available NF instances and their supported services. As used herein, the terms “instantiate,” “instantiation,” and the like may refer to the creation of an instance, and an “instance” may refer to a concrete occurrence of an object, which may occur, for example, during the execution of program code. Additionally, the NRF 254 may exhibit the Nnrf service-based interface.

The PCF 256 may provide policy rules to control plane functions to enforce them, and may also support a unified policy framework to govern network behavior. The PCF 256 may also implement a front end to access subscription information relevant for policy decisions in a UDR of the UDM 258. In addition to communicating with functions over reference points as shown, the PCF 256 exhibits an Npcf service-based interface.

The UDM 258 may handle subscription-related information to support the network entities' handling of communication sessions and may store the subscription data of UE 202. For example, subscription data may be communicated via an N8 reference point between the UDM 258 and the AMF 244. The UDM 258 may include two parts, an application front end, and a UDR. The UDR may store subscription data and policy data for the UDM 258 and the PCF 256, and/or structured data for exposure and application data (including PFDs for application detection, application request information for multiple UEs 202) for the NEF 252. The Nudr service-based interface may be exhibited by the UDR 221 to allow the UDM 258, PCF 256, and NEF 252 to access a particular set of the stored data, as well as to read, update (e.g., add, modify), delete, and subscribe to the notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re)selection and traffic routing. Based on operator deployment, when AF 260 is considered to be a trusted entity, the network operator may permit AF 260 to interact directly with relevant NFs. Additionally, the AF 260 may exhibit a Naf service-based interface.

The data network 236 may represent various network operator services, Internet access, or third-party services that may be provided by one or more servers including, for example, application/content server 238.

FIG. 3 schematically illustrates a wireless network 300 in accordance with various embodiments. The wireless network 300 may include a UE 302 in wireless communication with AN 304. The UE 302 and AN 304 may be similar to, and substantially interchangeable with, like-named components described elsewhere herein.

The UE 302 may be communicatively coupled with the AN 304 via connection 306. The connection 306 is illustrated as an air interface to enable communicative coupling and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and Internet (for example, IP) operations

The protocol processing circuitry 314 may implement one or more layer operations to facilitate transmission or reception of data over the connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and antenna panels 326 (referred generically as “transmit/receive components”) may be specific to details of a specific implementation such as, for example, whether the communication is TDM or FDM, in mmWave or sub-6 GHz frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the antenna panels 326, RFFE 324, RF circuitry 322, receive circuitry 320, digital baseband circuitry 316, and protocol processing circuitry 314. In some embodiments, the antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and antenna panels 326. In some embodiments, the transmit components of the UE 302 may apply a spatial filter to the data to be transmitted to form a transmit beam emitted by the antenna elements of the antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The processors 410 may include, for example, a processor 412 and a processor 414. The processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 430 may include interconnection or network interface controllers, components, or other suitable devices to communicate with one or more peripheral devices 404 or one or more databases 406 or other network elements via a network 408. For example, the communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the processors 410 to perform any one or more of the methodologies discussed herein. The instructions 450 may reside, completely or partially, within at least one of the processors 410 (e.g., within the processor's cache memory), the memory/storage devices 420, or any suitable combination thereof. Furthermore, any portion of the instructions 450 may be transferred to the hardware resources 400 from any combination of the peripheral devices 404 or the databases 406. Accordingly, the memory of processors 410, the memory/storage devices 420, the peripheral devices 404, and the databases 406 are examples of computer-readable and machine-readable media.

For one or more embodiments, at least one of the components outlined in one or more of the preceding figures may be configured to perform one or more operations, techniques, processes, and/or methods as outlined in the example sections below. For example, baseband circuitry associated with one or more of the preceding figures may be configured to operate in accordance with one or more of the examples set forth below. For another example, circuitry associated with a UE, base station, satellite, network element, etc. as described above in connection with one or more of the preceding figures may be configured to operate in accordance with one or more of the examples set forth below in the example section.

The term “application” may refer to a complete and deployable package, environment to achieve a certain function in an operational environment. The term “AI/ML application” or the like may be an application that contains some artificial intelligence (AI)/machine learning (ML) models and application-level descriptions. In some embodiments, an AI/ML application may be used for configuring or implementing one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical model(s) (referred to as “ML models” or the like) based on sample data (referred to as “training data,” “model training information,” or the like) to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principal component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML-assisted solution using the output of the ML model inference). The term “ML training host” refers to an entity, such as a network function, that hosts the training of the model. The term “ML inference host” refers to an entity, such as a network function, that hosts the model during inference mode (which includes both the model execution as well as any online learning if applicable). The ML-host informs the actor about the output of the ML algorithm, and the actor decides for an action (an “action” is performed by an actor as a result of the output of an ML-assisted solution). The term “model inference information” refers to information used as an input to the ML model for determining inference(s); the data used to train an ML model and the data used to determine inferences may overlap, however, “training data” and “inference data” refer to different concepts.

As used herein, the term “non-terrestrial networks” (or NTNs) indicates networks, or segments of networks, using an airborne or space-borne vehicle configured as a transmission equipment relay node or a base station. In this regard, a non-terrestrial network may use RF resources on board a satellite (or unmanned aircraft system (UAS) platform).

As used herein, the term “NTN-gateway” (or “NTN Gateway” or “gateway” or “sat-gateway”) indicates that an earth station or gateway is located at the surface of the Earth, and provides sufficient RF power and RF sensitivity for accessing to the satellite. In some aspects, NTN Gateway is a transport network layer (TNL) node.

As used herein, the term “regenerative payload” indicates a payload that transforms and amplifies an uplink RF signal before transmitting it on the downlink. The transformation of the signal refers to digital processing that may include demodulation, decoding, re-encoding, re-modulation, and/or filtering.

As used herein, the term “round trip delay” indicates the time required for a signal to travel from a terminal to the sat-gateway or from the sat-gateway to the terminal and back. This delay may be used in connection with web-based applications.

As used herein, the term “satellite” (or satellite node) indicates a space-borne vehicle embarking a bent pipe payload or a regenerative payload telecommunication transmitter, placed into Low-Earth Orbit (LEO), Medium-Earth Orbit (MEO), or Geostationary Earth Orbit (GEO). As used herein, the term “satellite beam” indicates a beam generated by an antenna on-board a satellite. As used herein, the term “service link” indicates a radio link between a satellite and a UE.

As used herein, the term “transparent payload” indicates a payload that changes the frequency carrier of the uplink RF signal, filters, and amplifies it before transmitting it on the downlink.

In some embodiments, a non-terrestrial network refers to a network, or segment of networks using RF resources on board a satellite (or UAS platform).

FIG. 5 and FIG. 6 illustrate example scenarios of a non-terrestrial network providing access to a user equipment. More specifically, FIG. 5 illustrates a non-terrestrial network 500 using a non-transparent payload, according to some embodiments. FIG. 6 illustrates a non-terrestrial network 600 using a regenerative payload, according to some embodiments.

In some embodiments, the disclosed NTNs may include one or more of the following elements: (a) at least one gateway connecting the NTN to a data network; (b) a GEO satellite fed by at least one gateway deployed across the satellite targeted coverage; (c) a non-GEO satellite served by one or multiple gateways at any given time; (d) a feeder link or radio link between a gateway (e.g., a sat-gateway) and the satellite (or UAS platform); (e) a service link or a radio link between the UE and the satellite (or UAS platform); (f) a satellite (or UAS platform) configured with a transparent or a regenerative payload (the satellite may generate multiple beams over a service area bounded by its field of view, where the footprints of the beams may be of elliptic shape); (g) a transparent payload; (h) a regenerative payload (e.g., RF filtering, frequency conversion and amplification as well as demodulation/decoding, switch and/or routing, coding/modulation may be performed, which may be equivalent to having all or part of base station functionalities on board the satellite); (h) inter-satellite links (ISL) may be used optionally in case of a swarm of satellites (ISL may operate in an RF frequency or in optical bands); and (i) UEs may be served by the satellite within a targeted service area.

FIG. 7 illustrates a non-terrestrial network 700 including a networking-RAN architecture with a transparent satellite, according to some embodiments.

In some embodiments, a satellite payload may implement frequency conversion and an RF amplifier in both the uplink and the downlink. In this regard, the satellite repeats the NR-Uu radio interface from a feeder link (between the gateway and the satellite) to a service link (between the satellite and the UE) and vice versa.

In some embodiments, the satellite radio interface (SRI) on the feeder link is the NR-Uu (e.g., the satellite does not terminate NR-Uu), and the gateway supports functionality for forwarding the signal received via the NR-Uu interface. In some embodiments and as illustrated in FIGS. 7-9, transparent satellites may be connected to the same gNB on the ground.

FIG. 8 illustrates a non-terrestrial network 800 including a regenerative satellite without inter-satellite links (ISL), according to some embodiments.

In some embodiments, a satellite payload may be configured for regeneration of the signals received from Earth, where the NR-Uu interface may be used on the service link between the UE and the satellite, and a satellite radio interface (SRI) may be used on the feeder link between the gateway and the satellite. In some embodiments, the SRI may be configured as a transport link between the gateway and the satellite. In some embodiments, the satellite payload may be associated with ISL between multiple satellites. In some aspects, ISL may be configured as a radio interface or an optical interface (e.g., 3GPP or non-3GPP defined). In some aspects, the gateway may be configured as a transport network layer node supporting one or more transport protocols.

FIG. 9 illustrates a non-terrestrial network 900 including a regenerative satellite with ISL, according to some embodiments. More specifically, FIG. 9 illustrates that a UE served by a gNB on board a satellite could access a 5G core network via the ISL. In some aspects, the gNB may be configured onboard different satellites and may be connected to the same 5G core network on the ground. In some embodiments when the satellite hosts more than one gNB, the same SRI may be used for transporting NG interface instances.

In some embodiments, NR positioning enhancements in Rel-17 may address the higher location accuracy and the lower latency requirements resulting from the new application and use cases. A target for the (I)IoT use cases may be to achieve less than or equal to 0.2 m distance error for the 80%-90% of users.

One of the limiting factors for the high positioning accuracy is the possible timing errors existing between the TX and RX chains at the gNB and UE sides, caused by the non-ideal synchronization and the RF circuit impairments. The timing errors may lead to significant degradation of the distance measurements and as a result of the entire positioning accuracy.

To achieve the accuracy of 0.2 m defined for the (I)IoT use case, the TX and RX timing may be estimated and compensated. The disclosed techniques include a method for estimation and compensation of the TX and RX timing errors at the gNB and UE sides as well as the measurement report format and associated signaling to support standard-based solutions.

The proposed techniques for transmitting and receiving timing errors estimation and compensation consists of three stages. The first stage includes a network-based timing error estimate at the gNB or Transmission Reception Point (TRP) side. The timing errors are computed between the gNB node pairs (or TRPs) using the propagation time delay measurements which are compared to the reference propagation time delay. A reference (calibrated) time delay is calculated based on the ideal knowledge of the gNBs (or TRPs) spatial coordinates (or geographical coordinates) and relative distance computations. In general, the gNB (or TRP) may have different (non-correlated) timing errors at the transmit (TX) and receive (RX) chains. Therefore, the procedure may include separate TX and RX timing errors measurements as well as the total error estimate, comprising the sum of these errors.

The second stage includes a user-based timing error estimate at the User Equipment (UE) side. In that case, the timing errors are computed between the UE and each gNB (or TRP) of the network. This measurement relies on the assumption, that the associated network-based error has been estimated at the previous stage and can be potentially compensated to facilitate a UE side errors estimate.

The third stage includes compensation of the network-based and the UE-based timing errors.

In the following disclosure, each stage is described in greater detail.

### First Stage—Network-Based Timing Error Estimation

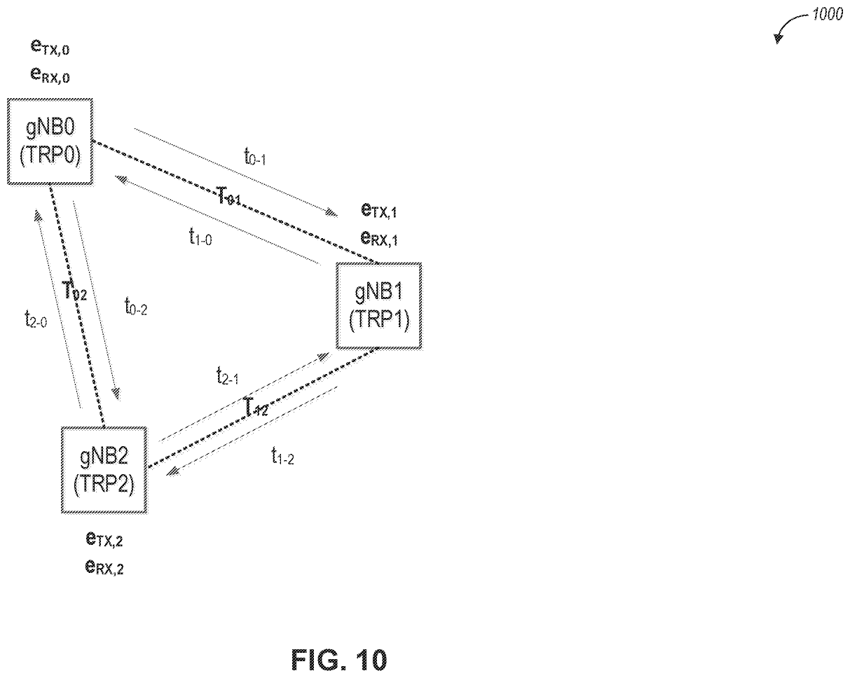

An example of three gNBs or Transmission Points (TRPs) comprising the network with known spatial coordinates is shown in FIG. 10, where each gNBi has an internal TX timing error—e_{TX,i} and RX timing error—e_{RX,i}.

FIG. 10 illustrates a diagram 1000 of network-based TX/RX timing errors estimation, according to some embodiments. The errors can be different and potentially caused by independent sources. Additionally, the ideal propagation time delay Tᵢⱼ between each pair of gNBs with indexes i and j is known (computed based on the ideal knowledge of the gNB coordinates).

Each gNB node can estimate a propagation time delay with any other gNB node in the network. First, the gNBi sends a reference signal to the node gNBj, which estimates the propagation time delay tᵢ₋ⱼ. Second, they interchange the roles and now the gNBj sends a reference signal to the node gNBi, which results in the measurement of the propagation time delay tⱼ₋ᵢ. Based on the obtained time delay measurements, the system of equations (1) can be written as:

$$\{ \begin{matrix}{T}_{01} + {e}_{T X , 0} + {e}_{RX , 1} = {t}_{0 - 1} \\ {T}_{01} + {e}_{TX , 1} + {e}_{RX , 0} = {t}_{1 - 0} \\ {T}_{02} + {e}_{TX , 0} + {e}_{RX , 2} = {t}_{0 - 2} \\ {T}_{02} + {e}_{TX , 2} + {e}_{RX , 0} = {t}_{2 - 0} \\ {T}_{12} + {e}_{TX , 1} + {e}_{RX , 2} = {t}_{1 - 2} \\ {T}_{12} + {e}_{TX , 2} + {e}_{RX , 1} = {t}_{2 - 1}\end{matrix} , \qquad ( 1 )$$

where tᵢ₋ⱼ—is the time measurement performed between the gNBi (transmitter) and gNBj (receiver), estimated at the gNBj, i.e. receiver side. The system of equations (1) can be written in a concise matrix form as follows:

He=Δt, (2)

where, for the provided example, matrix H, error vector e, and the observation difference vector Δt can be introduced as:

$$H = [ \begin{matrix}1 & 0 & 0 & 0 & 1 & 0 \\ 0 & 1 & 0 & 1 & 0 & 0 \\ 1 & 0 & 0 & 0 & 0 & 1 \\ 0 & 0 & 1 & 1 & 0 & 0 \\ 0 & 1 & 0 & 0 & 0 & 1 \\ 0 & 0 & 1 & 0 & 1 & 0\end{matrix} ] , e = [ \begin{matrix}{e}_{TX , 0} \\ {e}_{TX , 1} \\ {e}_{TX , 2} \\ {e}_{RX , 0} \\ {e}_{RX , 1} \\ {e}_{RX , 2}\end{matrix} ] , Δ t = [ \begin{matrix}{t}_{0 - 1} - {T}_{01} \\ {t}_{1 - 0} - {T}_{01} \\ {t}_{0 - 2} - {T}_{02} \\ {t}_{2 - 0} - {T}_{02} \\ {t}_{1 - 2} - {T}_{12} \\ {t}_{2 - 1} - {T}_{12}\end{matrix} ] . \qquad ( 3 )$$

H is the 6×6 network matrix, and it consists of zero and one elements, where ones correspond to the nodes used in the measurement and zeros to the nodes not used in the respective measurement. e is the 6×1 error vector, it consists of the error values for each gNB node (or TRP) for TX and RX sides separately. At is the 6×1 observation difference vector, where its elements represent a difference between the observed (measured) value tᵢ₋ⱼ and the reference (ideal) value Tᵢⱼ.

For a given network matrix H and the observation vector Δt, an algorithm should estimate the error vector e. Then this vector can be used for calibration of the network-based timing errors.

Estimation of TX and RX Errors with Calibrated Source

It can be noted that the matrix H has a rank of 5, while the system of equations (2) has six unknowns. This means that the matrix H is a singular matrix and the system of equations (2) cannot be solved uniquely.

However, the solution still can be found, if one of the sources in the network is calibrated, i.e. its timing error is equal to zero (compensated) or known in advance (equal to some constant C). Without loss of generality, it may be assumed that the gNB0 (or TRP0) in FIG. 10 has a known TX timing error equal to C₀. In that case, the system of equations (2) can be modified to replace the e_{TX,0} with a known constant C₀, and reducing the total number of variables from 6 to 5, to obtain:

$$\begin{matrix}\tilde{H} \tilde{e} = \tilde{Δ t} , & ( 4 ) \\ where & \\ \tilde{H} = [ \begin{matrix}0 & 0 & 0 & 1 & 0 \\ 1 & 0 & 1 & 0 & 0 \\ 0 & 0 & 0 & 0 & 1 \\ 0 & 1 & 1 & 0 & 0 \\ 1 & 0 & 0 & 0 & 1 \\ 0 & 1 & 0 & 1 & 0\end{matrix} ] , \tilde{e} = [ \begin{matrix}{\tilde{e}}_{TX , 1} \\ {\tilde{e}}_{TX , 2} \\ {\tilde{e}}_{RX , 0} \\ {\tilde{e}}_{RX , 1} \\ {\tilde{e}}_{RX , 2}\end{matrix} ] , \tilde{Δ t} = [ \begin{matrix}{t}_{0 - 1} - {T}_{01} - {C}_{0} \\ {t}_{1 - 0} - {T}_{01} \\ {t}_{0 - 2} - {T}_{02} - {C}_{0} \\ {t}_{2 - 0} - {T}_{02} \\ {t}_{1 - 2} - {T}_{12} \\ {t}_{2 - 1} - {T}_{12}\end{matrix} ] . & ( 5 )\end{matrix}$$

\tilde{H} is the new network matrix with a reduced row dimension of 6×5, \tilde{e} is the new 5×1 error vector of reduced dimension, and [symbol] at is the modified 6×1 observation difference vector with compensated error C₀. This gives us a new system of equations with respect to the rest of the 5 TX and RX errors, that can be solved uniquely.

The matrix (\tilde{H}^{T}, \tilde{H}) is invertible and the solution for the vector d can be found in the form:

\tilde{e}=(\tilde{H}^{T}, \tilde{H})⁻¹H^{T}Δt (6)

where (\tilde{H}^{T}, \tilde{H})⁻¹ is the inverse 5×5 matrix of the original network matrix (\tilde{H}^{T}, \tilde{H}).

In general, the provided example of three gNBs (or TRPs) can be extended to any case of N gNBs (or TRPs). Consequently, the rank of the network matrix H will be equal to (N−1) and the total number of equations equal to N. The same approach can be applied to solve the system if one of the nodes has a calibrated (known) timing error.

In some aspects, any TX or RX timing error in the system of equations (2) can be selected as known, i.e. calibrated. This will change a modified set of equations (4), but will not change a basic principle behind this approach.

In case if more errors are known in advance, this will introduce some redundancy into the system of equations and consequently improves the accuracy of errors estimation, especially if some noise components affect the observation difference vector Δt.

### Estimation of Total Timing Errors

Although the TX and RX timing errors cannot be found separately for the original system of equations (1), the total timing error, comprising the sum of the TX and RX errors can be found explicitly.

To illustrate that, a simple transformation may be applied to the original system equations (1), where the first row is added to the second row, the third row is added to the fourth row, and the fifth row is added to the sixth row. Additionally, the timing constants Tᵢⱼ is moved to the right-hand side for simplicity. As a result, the following new system of equations is obtained in the form.

$$\{ \begin{matrix}{e}_{TX , 0} + {e}_{RX , 0} + {e}_{T X , 1} + {e}_{RX , 1} = {t}_{0 - 1} + {t}_{1 - 0} - 2 {T}_{01} \\ {e}_{TX , 0} + {e}_{RX , 0} + {e}_{TX , 2} + {e}_{RX , 2} = {t}_{0 - 2} + {t}_{2 - 0} - 2 {T}_{02} \\ {e}_{TX , 1} + {e}_{RX , 1} + {e}_{T X , 2} + {e}_{R X , 2} = {t}_{1 - 2} + {t}_{1 - 2} - 2 {T}_{12}\end{matrix} . \qquad ( 7 )$$

Introducing notations for the total TX-RX timing error eᵢ=e_{TX,i}+e_{RX,i} and the time difference between the measured and known time delay, Δtᵢ₋ⱼ=tᵢ₋ⱼ−Tᵢⱼ, the following modified system of equations is obtained:

$$\{ \begin{matrix}{e}_{0} + {e}_{1} = Δ {t}_{0 - 1} + Δ {t}_{1 - 0} \\ {e}_{0} + {e}_{2} = Δ {t}_{0 - 2} + Δ {t}_{2 - 0} \\ {e}_{1} + {e}_{2} = Δ {t}_{1 - 2} + Δ {t}_{2 - 1}\end{matrix} \qquad ( 8 )$$

Using matrix notations, (8) can be written as:

Ae=Δt, (9)

where, for the provided example, matrix A, error vector e, and the observation difference vector Δt can be introduced as:

$$A = [ \begin{matrix}1 & 1 & 0 \\ 1 & 0 & 1 \\ 0 & 1 & 1\end{matrix} ] , e = [ \begin{matrix}{e}_{0} \\ {e}_{1} \\ {e}_{2}\end{matrix} ] , Δ t = [ \begin{matrix}Δ {t}_{0 - 1} + Δ {t}_{1 - 0} \\ Δ {t}_{0 - 2} + Δ {t}_{2 - 0} \\ Δ {t}_{1 - 2} + Δ {t}_{2 - 1}\end{matrix} ] . \qquad ( 10 )$$

A is the 3×3 modified network matrix for the total timing error, and it consists of zero and one elements, where ones correspond to the nodes used in the measurement and zeros for the nodes not used in the respective measurement. Vector e is the 3×1 error vector, it consists of the total error values for each gNB node (or TRP). Δt is the 3×1 observation difference vector, where its elements represent a sum of differences between the observed (measured) value tᵢ₋ⱼ and the reference (ideal) value Tᵢⱼ and the observed value tⱼ₋ᵢ and the reference value Tⱼᵢ.

The modified network matrix A has a full rank of 3, therefore it is invertible, and the error vector estimate can be found as:

e=A⁻¹Δt, (11)

where A⁻¹ is the inverse 3×3 matrix of the original matrix A. In the provided example, it can be found as:

$${A}^{- 1} = \frac{1}{2} [ \begin{matrix}1 & 1 & - 1 \\ 1 & - 1 & 1 \\ - 1 & 1 & 1\end{matrix} ] . \qquad ( 12 )$$

Therefore, as opposed to the case of the separate TX and RX timing errors estimate, the total TX-RX timing errors can be computed without a need to have a calibrated source in the network.

In some embodiments, the proposed algorithm for the total TX-RX timing error estimate at the gNB (or TRP) side can be extended to any number of gNBs N. The measurements can be performed between each pair of nodes in the entire network of N nodes or inside any subnetwork with the total number of gNB (or TRP) nodes M≤N.

### Second Stage—UE-Based Timing Error Estimation

At the second stage, a user-based timing error estimation is performed at the User Equipment (UE) side.

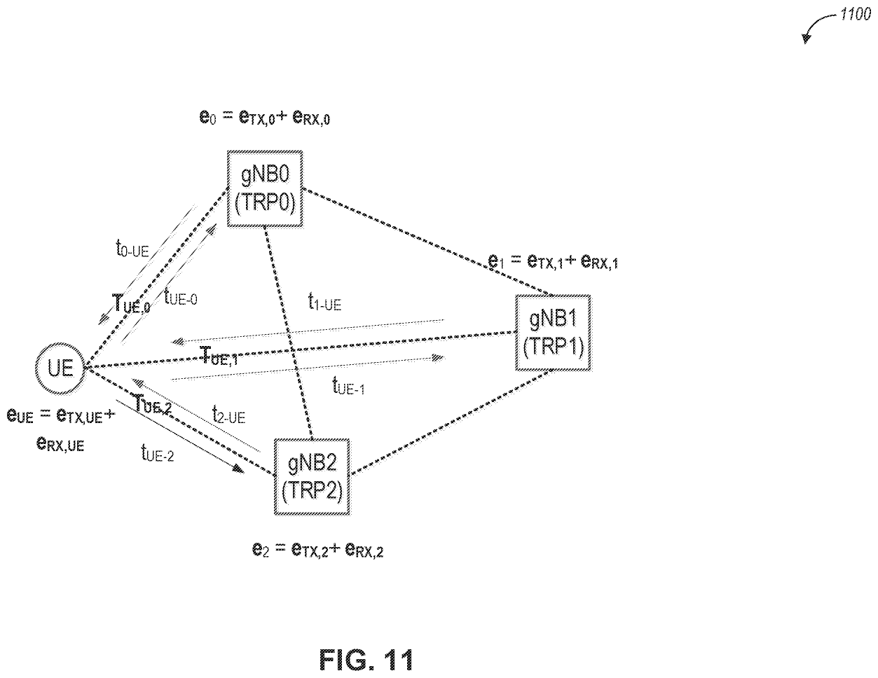

An example of three gNBs or Transmission Points (TRPs) comprising the network with known spatial coordinates and a UE with unknown coordinates performing distance measurements with these gNBs (or TRPs) shown in FIG. 11.

FIG. 11 illustrates a diagram 1100 with an example of user-based TX/RX timing errors estimation, according to some embodiments.

In addition to the network timing errors considered above, a UE has its own internal TX timing error—e_{TX,UE} and RX timing error—e_{RX,UE}. These errors can be different and potentially caused by independent sources.

As opposed to the network-based measurements considered above, the ideal propagation time delay T_{UE,i} (highlighted in red) between a UE and gNBi (or TRP) in the general case is not known and only propagation time delay measurements t_{UE-i} between a UE and gNBi (or TRP) are available.

A UE can estimate a propagation time delay with any gNB node in the network. In the case of the UE-based approach, it starts the measurement procedure. First, a UE sends a reference signal to the node gNBi, which estimates the propagation time delay t_{UE-i}. Second, they interchange the roles and now the gNBi sends a reference signal to a UE, which results in the measurement of the propagation time delay t_{i-UE}.

In the case of the UE-assisted approach, the gNBi starts the measurement procedure. First, the gNBi sends a reference signal to a UE, which estimates the propagation time delay t_{i-UE}. Second, they interchange the roles and now a UE sends a reference signal to the gNBi, which results in the measurement of the propagation time delay t_{UE-i}.

Based on the obtained time delay measurements, the system of equations (13) can be written as:

$$\{ \begin{matrix}{T}_{UE , 0} + {e}_{T X , 0} + {e}_{RX , UE} = {t}_{0 - UE} \\ {T}_{UE , 0} + {e}_{TX , UE} + {e}_{RX , 0} = {t}_{UE - 0} \\ {T}_{UE , 1} + {e}_{TX , 1} + {e}_{RX , UE} = {t}_{1 - UE} \\ {T}_{UE , 1} + {e}_{TX , UE} + {e}_{RX , 1} = {t}_{UE - 1} \\ {T}_{UE , 2} + {e}_{TX , 2} + {e}_{RX , UE} = {t}_{2 - UE} \\ {T}_{UE , 2} + {e}_{TX , UE} + {e}_{RX , 2} = {t}_{UE - 2}\end{matrix} , \qquad ( 13 )$$

where t_{i-UE}—is the time measurement performed between the gNBi (transmitter) and the UE (receiver) estimated at the UE, i.e. receiver side and where t_{UE-i}—is the time measurement performed between a UE (transmitter) and the gNBi (receiver) estimated at the gNBi, i.e. receiver side.

A simple transformation may be applied to the original system equations (13), where the first row is added to the second row, the third row is added to the fourth row, and the fifth row is added to the sixth row. Additionally, the timing constants T_{UE,i} are moved to the right-hand side for simplicity. As a result, a new system of equations is obtained in the following form:

$$\{ \begin{matrix}2 {T}_{UE , 0} + {e}_{TX , UE} + {e}_{RX , UE} = {t}_{0 - UE} + {t}_{UE - 0} - ( {e}_{TX , 0} + {e}_{RX , 0} ) \\ 2 {T}_{UE , 1} + {e}_{TX , UE} + {e}_{RX , UE} = {t}_{1 - UE} + {t}_{UE - 1} - ( {e}_{TX , 1} + {e}_{RX , 1} ) \\ 2 {T}_{UE , 2} + {e}_{TX , UE} + {e}_{RX , UE} = {t}_{2 - UE} + {t}_{UE - 2} - ( {e}_{TX , 2} + {e}_{RX , 2} )\end{matrix} . \qquad ( 14 )$$

Introducing notations for the total TX-RX timing error at the UE side e_{UE}=e_{TX,UE}+e_{RX,UE}, recalling notations for the gNBi eᵢ=e_{TX,i}+e_{RX,i} used above, the following modified system of equations is obtained:

$$\{ \begin{matrix}2 {T}_{UE , 0} + {e}_{UE} = {t}_{0 - UE} + {t}_{UE - 0} - {e}_{0} \\ 2 {T}_{UE , 1} + {e}_{UE} = {t}_{1 - UE} + {t}_{UE - 1} - {e}_{1} \\ 2 {T}_{UE , 2} + {e}_{UE} = {t}_{2 - UE} + {t}_{UE - 2} - {e}_{2}\end{matrix} . \qquad ( 15 )$$

To further simply (15), we introduce a notation for the measured propagation time delay between a UE and gNBi after network timing error compensation as:

$${t}_{i} = \frac{{t}_{i - UE} + {t}_{UE - i} - {e}_{i}}{2} . \qquad ( 16 )$$

Therefore, (15) can be modified as follows:

$$\{ \begin{matrix}{T}_{UE , 0} + \frac{{e}_{UE}}{2} = {t}_{0} \\ {T}_{UE , 1} + \frac{{e}_{UE}}{2} = {t}_{1} \\ {T}_{UE , 2} + \frac{{e}_{UE}}{2} = {t}_{2}\end{matrix} . \qquad ( 17 )$$

if some of the propagation time delays TUE,i between a UE and gNBi in (17) are known, then the UE error can be directly estimated using these equations. In the opposite case, one equation is subtracted from another to compensate for the UE side timing error impact.

In some embodiments, if UE coordinates are known (for example, obtained with RAT-independent method, using GNSS), then a UE can be considered as one of the network nodes shown in FIG. 10Error! Reference source not found. and perform its timing errors calibration based on the procedure described in stage one above.

### Third Stage—Errors Compensation, Impact on Positioning Equations

At the third stage, the UE timing error compensation is performed by subtraction of one equation from another.

Multiplying both sides on c, which denotes a speed of light, the timing equations (17) is converted into the distance equations:

$$\{ \begin{matrix}{r}_{UE , 0} + \frac{{w}_{UE}}{2} = {r}_{0} \\ {r}_{UE , 1} + \frac{{w}_{UE}}{2} = {r}_{1} \\ {r}_{UE , 2} + \frac{{w}_{UE}}{2} = {r}_{2}\end{matrix} \qquad ( 18 )$$

where r_{UE,i}—is the distance between a UE and gNBi, r_{UE,i}=c×T_{UE,i}, w_{UE}—is the total distance error for a UE, w_{UE}=c×e_{UE}. and rᵢ—is the measured distance between a UE and gNBi, rᵢ=c×tᵢ.

To compensate for the distance error w_{UE}/2 in the system of equations (18), the second row is subtracted from the first row, the third row from the first row, and the third row from the second row. The following modified system equations are obtained.

$$\{ \begin{matrix}{r}_{UE , 0} - {r}_{UE , 1} = {r}_{0} - {r}_{1} \\ {r}_{UE , 0} - {r}_{UE , 2} = {r}_{0} - {r}_{2} \\ {r}_{UE .1} - {r}_{UE , 2} = {r}_{1} - {r}_{2}\end{matrix} . \qquad ( 19 )$$

The distance from a UE to the gNBi can be defined in the Cartesian coordinates as;

r_{UE,i}=\sqrt{(x−xᵢ)²+(y−yᵢ)²+(z−zᵢ)²}, (20)

where (x, y, z) are the unknown UE coordinates (to be estimated) and (xᵢ, yᵢ, zᵢ) are the known coordinates (used in estimation) of the gNBᵢ.

To simplify notations in (19), we introduce function ƒᵢⱼ(x,y,z) as a difference between the two distances r_{UE,i} and r_{UE,j} as follows:

ƒᵢⱼ(x,y,z)=r_{UE,i}−r_{UE,j}. (21)

Finally, the system of positioning equations is written as:

$$\{ \begin{matrix}{f}_{01} ( x , y , z ) = {r}_{0} - {r}_{1} \\ {f}_{02} ( x , y , z ) = {r}_{0} - {r}_{2} \\ {f}_{12} ( x , y , z ) = {r}_{1} - {r}_{2}\end{matrix} . \qquad ( 22 )$$

The system of equations (22) can be solved using Gauss-Newton techniques.

In some embodiments, the proposed algorithm for the total UE timing error compensation can be extended to any number of gNBs−N. The measurements can be performed between a UE and each gNB node in the entire network of N nodes or inside any subnetwork with the total number of gNB (or TRP) nodes M≤N.

The proposed generalized method for transmitting and receive timing errors estimation and compensation improves the positioning performance dramatically compared to the performance with no error compensation.

### Measurement Report and Signaling to Support Standard Based Solution

To support the proposed method in the standard, we suggest introducing three measurement reports (Information Elements) in the form specified below.

The disclosed measurement report may be sent by a UE to a single serving gNB or a single serving gNBs and multiple neighbor gNBs (TRPs). The measurement report may be sent by a UE to the Location Management Function (LMF) entity. The measurement report may be sent by a serving gNB or a serving gNB and multiple neighbor gNBs (TRPs) to the LMF entity.

The measurement report may be sent by an LMF entity to a serving gNB or a serving gNB and multiple neighbor gNBs (TRPs). The measurement report may be sent by an LMF entity to a UE. The measurement report may be sent by a serving gNB or a serving gNB and multiple neighbor gNBs (TRPs) to a UE.

### Measurement Report—Type 1

The measurement report of type 1 contains Information Element (IE) NR-TimingError with the fields specified below and illustrated in Table 1. This measurement feedback may be used by LMF, gNB, or UE to reconstruct a system of equations defined in (3).

The IE NR-TimingError is used by the target device to provide information about the time difference (Δtij) between the measured propagation time delay (tij) and the reference propagation time delay (Tij) between any two nodes in the network, see equation (3). The nr-relativeTimeDfference is the measured time difference (Δtij) value, and each value is associated with a quality value nr-timing-Quality.

An example of the IE possible format is provided below in Table 1. Note, that in general k0-r17, k1-r17, . . . , k5-r17 can take any integer value.

TABLE 1
-- ASN1START
NR-TimingError-r17 ::= SEQUENCE (SIZE(1..2)) OF NR-TimingError-
r17
NR-TimingError-r17 ::= SEQUENCE {
nr-relativeTimeDifference-r17 CHOICE {

| | |
|---|---|
| k0417 | INTEGER(0..16351), |
| k1-r17 | INTEGER(0..8176), |
| k2-r17 | INTEGER(0..4088), |
| k3-r17 | INTEGER(0..2044), |
| k4-r17 | INTEGER(0..1022), |
| k5-r17 | INTEGER(0..511), |

| | |
|---|---|
| } | |
| ... | |
| nr-timing-Quality-r17 | NR-TimingQuality-r17 |
| OPTIONAL, | |
| } | |
| -- ASN1STOP | |

NR-TimingError field descriptions
nr-relativeTimeDifference
This field specifies the time difference (Δtᵢⱼ) between the actual measured
propagation time delay (tᵢⱼ) and the reference propagation time delay (Tᵢⱼ)
between any two nodes in the network. A positive value indicates that the
actual measured propagation time delay is larger than the reference
propagation time delay; a negative value indicates that the measured
propagation time delay is smaller than the reference propagation time
delay.
nr-timing-quality
This field specifies the target devices best estimate of the quality of the
measured time difference.

### Measurement Report—Type 2

The measurement report of type 2 contains Information Element (IE) NR-TotalTimingError with the fields specified below. This measurement feedback may be used by LMF, gNB, or UE to reconstruct a system of equations defined in (8).

The IE NR-TotalTimingError is used by the target device to provide information about the total (roundtrip) time difference (Δtᵢⱼ+Δtⱼᵢ) between the actual measured propagation roundtrip time delay (tᵢⱼ+tⱼᵢ) and the reference propagation roundtrip time delay (2Tᵢⱼ) between any two nodes in the network, see equation (8). The nr-relativeTimeDifference is the measured roundtrip time difference (Δtij+Δtᵢⱼ) value, and each value is associated with a quality value nr-timing-Quality.

An example of the IE possible format is provided below in Table 2. Note, that in general k0-r17, k1-r17, . . . , k5-r17 can take any integer value.

TABLE 2
ASN1START
NR-TotalTimingError-r17 ::= SEQUENCE (SIZE(1..2)) OF NR-
TotalTimingError-r17
NR-TotalTimingError-r17 ::= SEQUENCE {
nr-relativeTimeDifference-r17 CHOICE {

| | |
|---|---|
| k0-r17 | INTEGER(0..16351), |
| k1-r17 | INTEGER(0..8176), |
| k2-r17 | INTEGER(0..4088), |
| k3-r17 | INTEGER(0..2044), |
| k4-r17 | INTEGER(0..1022), |
| k5-r17 | INTEGER(0..511), |

| | |
|---|---|
| } | |
| ... | |
| nr-timing-Quality-r17 | NR-TimingQuality-r17 |
| OPTIONAL, | |
| } | |
| -- ASN1STOP | |

NR-TotalTimingError field descriptions
nr-relativeTimeDifference
This field specifies the roundtrip time difference (Δtᵢⱼ + Δtⱼᵢ)
between the actual measured propagation roundtrip time delay
(tᵢⱼ + tⱼᵢ) and the reference propagation roundtrip time delay (2Tᵢⱼ)
between any two nodes in the network. A positive value indicates
that the actual measured roundtrip propagation time delay is larger
than the reference propagation roundtrip time delay; a negative
value indicates that the measured propagation roundtrip
time delay is smaller than the reference propagation roundtrip
time delay.
nr-timing-quality
This field specifies the target devices best estimate of the quality
of the measured time difference.

### Measurement Report—Type 3

The measurement report of type 3 contains Information Element (IE) NR-TxRxTimingError with the fields specified below. This measurement feedback may be used by LMF, gNB, or UE to compute the propagation time delay between a UE and gNB, with compensated network timing error (see (16)). Then it may be used to solve the system of equations (17).

The IE NR-TxRxTimingError is used by the target device to provide information about the total timing error (e), comprising the sum of transmit and receive timing errors (e=e_{TX}+e_{RX}) for any node in the network, see equations (7) and (8). The nr-txRxTimingError is the measured total timing error (e=e_{TX}+e_{RX}) value, and each value is associated with a quality value nr-timing-Quality.

An example of the IE possible format is provided below in Table 3. Note, that in general k-r17, k1-r17, . . . , k5-r17 can take any integer value.

TABLE 3
-- ASN1START
NR-TxRxTimingError-r17 : := SEQUENCE (SIZE (1..2)) OF NR-
TxRxTimingError-r17
NR-TxRxTimingError-r17 ::= SEQUENCE {
nr-txRxTimingError-r17 CHOICE {

| | |
|---|---|
| k0417 | INTEGER(0..16351), |
| k1-r17 | INTEGER(0..8176), |
| k2-r17 | INTEGER(0..4088), |
| k3-r17 | INTEGER(0..2044), |
| k4-r17 | INTEGER(0..1022), |
| k5-r17 | INTEGER(0..511), |

}
...

| | |
|---|---|
| nr-timing-Quality-r17 | NR-TimingQuality-r17 |

OPTIONAL,
}
-- ASN1STOP

NR-TxRxTimingError field descriptions
nr-txRxTimingError
This filed specifies the total timing error (e), comprising the sum of
transmit and receive timing errors (e = e_{TX} + e_{RX}) for any node in
the network. A positive value indicates that the absolute measured
error should be subtracted from the actual measured propagation
time delay to get a correct timing estimate; a negative value
indicates that the absolute measured error should be added to the
actual measured propagation time delay to get a correct timing
estimate.
nr-timing-quality
This field specifies the target devices best estimate of the quality of
the measured timing error.

### Measurement Quality Field Definition

The measurement quality field contains Information Element (IE) NR-Timing-Quality with the subfields specified below. This field may be used as a part of the measurements of types 1, 2, and 3 specified above.

An example of the IE possible format is provided below in Table 4. Note, that in general timingQualityValue-r17 can take any integer value and timingQualityResolution-r17 may define any resolution, represented in meters, including an fractional arts.

TABLE 4
-- ASN1START
NR-TimingQuality-r17 ::= SEQUENCE {

| | |
|---|---|
| timingQualityValue-r17 | INTEGER (0..31), |
| timingQualityResolution-r17 | ENUMERATED {x0, x1, x2, x3, |
| x4, ...}, | |
| ... | |
| } | |
| -- ASN1STOP | |

NR-TimingQuality field descriptions
timingQuality Value
This field provides an estimate of uncertainty of the timing value
for which the IE NR-TimingQuality is provided in units of
meters.
timingQualityResolution
This field provides the resolution used in the timingQualityValue
field. Enumerated values x0, x1, x2, x3, x4 may correspond to
the 0.001, 0.01, 0.1, 1, 10 meters, respectively. Any other
resolution as a fractional part of meter is possible.

In some embodiments, a device comprising storage and processing circuitry coupled to storage is disclosed. The processing circuitry is configured to perform network-based transmit (TX) and receive (RX) timing errors estimation, as well as the total error estimation, comprising the sum of the TX and RX timing errors. In some embodiments, the processing circuitry is configured to perform UE-based TX and RX timing errors estimation, as well as the total timing error estimation, comprising the sum of the TX and RX timing errors. In some embodiments, the processing circuitry is configured to compensate for the estimated network-based TX and/or RX timing errors, as well as the total error, comprising the sum of the TX and RX timing errors. In some embodiments, the processing circuitry is configured to compensate for the estimated UE-based TX and/or RX timing errors, as well as the total error, comprising the sum of the TX and RX timing errors. In some embodiments, the processing circuitry is configured to send a measurement report containing the required information to perform any of the above functions. In some embodiments, the processing circuitry is configured to receive and process a measurement report containing the required information to perform any of the above functions.

In some embodiments, the compensation of UE-based timing errors is performed using an estimate of the network-based timing errors. In some aspects, the network is comprised of single or multiple gNB (or TRP) nodes. In some aspects, the network is comprised of single or multiple gNB (or TRP) nodes and single or multiple UE nodes. In some embodiments, a single or multiple gNBs (or TRPs), comprising a network have a calibrated timing source inside the network. In some embodiments, the measurement report includes a measurement report of type 1, specified above. In some aspects, the measurement report includes a measurement report of type 2, specified above. In some embodiments, the measurement report includes a measurement report of type 3, specified above.

In some aspects, a reference device may be enabled to perform measurements and reporting of timing-related parameters and support gNB and UE TX/RX timing errors calibration. The reference device has a known location and can be a reference UE and/or reference gNB/TRP.

The disclosed techniques consider an impact of the UE and gNB TX/RX timing errors on the accuracy of the timing-based positioning methods (DL-TDOA, UL-TDOA, and Multi-RTT) and propose methods to calibrate the UE and gNB with the multiple transmission and reception timing error groups using reference device with a known location.

This disclosure generalizes methods for transmit and receive timing errors calibration for the multi-TEG case and introduces the concept of the reference device.

### Timing Errors Impact on NR Positioning Methods

In this section, an impact of the TX/RX timing errors on the accuracy of DL-TDOA, UL-TDOA, and Multi-RTT positioning methods using multiple Timing Error Groups (TEGs) for transmission and reception are disclosed.

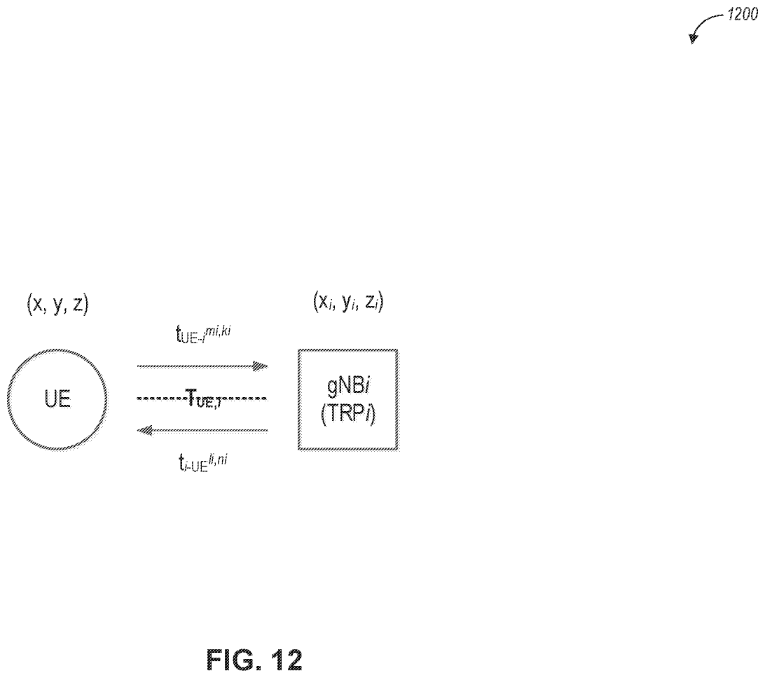

An example of i^{th} gNB or Transmission Reception Points (TRP) with known coordinates (xᵢ, yᵢ, zᵢ) is provided in FIG. 12, where gNBi node has an internal TX timing error—e_{TX,i}^{l}^{ᵢ} for the lᵢ^{th} TEG and RX timing error—e_{RX,i}^{k}^{ᵢ} for the kᵢ^{th} TEG.

FIG. 12 illustrates diagram 1200 of an example of timing measurements between a UE and i^{th} gNB/TRP, according to some embodiments.

The total TX+RX timing error of the gNBi can be found as a sum of the transmit and receive timing errors as eᵢ^{l}^{ᵢ}^{,k}^{ᵢ}=e_{TX,i}^{l}^{ᵢ}+e_{RX,i}^{k}^{ᵢ}.

A UE has its own internal TX timing error—e_{TX,UE}^{m}^{ᵢ} for the mᵢ^{th} TEG (used for transmission to gNBi), and RX timing error—e_{RX,UE}ⁿ^{ᵢ} for the nith TEG (used for reception from gNBi). The total TX+RX timing error of a UE can be found as a sum of the TX and RX timing errors as e_{UE}^{m}^{ᵢ}^{,n}^{ᵢ}=e_{TX,UE}^{m}^{ᵢ}+e_{RX,UE}ⁿ^{ᵢ}.

In the case of the DL-based methods, the gNBi sends a reference signal to a UE, and the propagation time t_{i-UE}^{l}^{ᵢ}^{,x}^{ᵢ} can be represented in the form:

t_{i-UE}ⁱ^{ᵢ}^{,n}^{ᵢ}=T_{UE,i}+e_{TX,i}^{l}^{ᵢ}+e_{RX,UE}ⁿ^{ᵢ}, (23)

where T_{UE,i} is the unknown reference propagation time, e_{TX,i}^{l}^{ᵢ} is the gNBi TX timing error for the lᵢ^{th} TEG, and e_{RX,UE}ⁿ^{ᵢ} is the UE RX timing error for the nᵢ^{th} TEG.

In the case of the UL-based methods, a UE sends a reference signal to the gNBi, and the propagation time t_{UE-i}^{m}^{ᵢ}^{,k}^{ᵢ} can be represented in the form:

t_{UE-i}^{m}^{ᵢ}^{,k}^{ᵢ}=T_{UE,i}+e_{TX,UE}^{m}^{ᵢ}+e_{RX,i}^{k}^{ᵢ}, (24)

where T_{UE,i} is the unknown reference propagation time, e_{TX,UE}^{m}^{ᵢ} is the UE TX timing error for the mᵢ^{th} TEG, and e_{RX,i}^{k}^{ᵢ} is the gNBi RX timing error for the kᵢ^{th} TEG.

The disclosure below discusses the impact of timing errors for each timing-based positioning method defined in the NR.

### DL-TDOA Positioning Method

The DL-TDOA positioning method performs the time difference measurements in the form:

$$DL - {RSTD}_{i , j} = {t}_{i - UE}^{{l}_{i} , {n}_{i}} - {t}_{j - UE}^{{l}_{j} , {n}_{j}} = ( {T}_{UE , i} + {e}_{TX , i}^{{l}_{i}} + {e}_{RX , UE}^{{n}_{i}} ) - ( {T}_{UE , j} + {e}_{TX , j}^{{l}_{j}} + {e}_{RX , UE}^{{n}_{j}} ) = ( {T}_{UE , i} - {T}_{UE , j} ) + ( {e}_{TX , i}^{{l}_{i}} - {e}_{TX , j}^{{l}_{j}} ) + ( {e}_{RX , UE}^{{n}_{i}} - {e}_{RX , UE}^{{n}_{j}} ) , \qquad ( 25 )$$

where (T_{UE,i}−T_{UE,j}) is the propagation time difference between a UE and the gNBi and gNBj, (e_{TX,i}^{l}^{ᵢ}−e_{TX,j}^{l}^{ⱼ}) is the TX timing error difference of gNBi with the lᵢ^{th} TEG and gNBj with the lⱼ^{th} TEG, and (e_{RX,UE}ⁿ^{ᵢ}−e_{RX,UE}ⁿ^{ⱼ}) is the RX timing error difference of the nᵢ^{th} and nⱼ^{th} UE TEGs.

(a) Observation 1:

(a.1) The gNB TX timing error difference degrades the performance of the DL-TDOA positioning method.

(a.2) The UE RX timing error difference may affect the DL-TDOA positioning method if UE uses different TEGs for different gNBs/TRPs

### UL-TDOA Positioning Method

The UL-TDOA positioning method performs the time difference measurements in the form:

$$UL - {RSTD}_{i , j} = {t}_{UE - i}^{{m}_{i} , {k}_{i}} - {t}_{UE - j}^{{m}_{j} , {k}_{j}} = ( {T}_{UE , i} + {e}_{TX , UE}^{{m}_{i}} + {e}_{RX , i}^{{k}_{i}} ) - ( {T}_{UE , j} + {e}_{TX , UE}^{{m}_{j}} + {e}_{RX , j}^{{k}_{j}} ) = ( {T}_{UE , i} - {T}_{UE , j} ) + ( {e}_{RX , i}^{{k}_{i}} - {e}_{RX , j}^{{k}_{j}} ) + ( {e}_{TX , UE}^{{m}_{i}} - {e}_{TX , UE}^{{m}_{j}} ) , \qquad ( 26 )$$

where (T_{UE,i}−T_{UE,j}) is the propagation time difference between a UE and the gNBi and gNBj (RTOA difference) and (e_{RX,i}^{k}^{ᵢ}−e_{RX,j}^{k}^{ⱼ}) is the RX timing error difference of gNBi with the kᵢ^{th} TEG and gNBj with the kⱼ^{th} TEG, and (e_{TX,UE}^{m}^{ᵢ}−e_{TX,UE}^{m}^{ⱼ}eTX, UEmj) is the RX timing error difference of the mᵢ^{th} and mⱼ^{th} UE TEGs.

(b) Observation 2:

(b.1) The gNB RX timing error difference degrades the performance of the UL-TDOA positioning method.

(b.2) The UE TX timing error difference may affect the UL-TDOA positioning method if UE uses different TEGs for different gNBs/TRPs.

### Multi-RTT Positioning Method

The Multi-RTT positioning method performs time measurements in the form:

$${mRTT}_{i} = \frac{{t}_{UE - i}^{{m}_{i} , {k}_{i}} + {t}_{i - UE}^{{l}_{i} , {n}_{i}}}{2} = \frac{( {T}_{UE , i} + {e}_{TX , UE}^{{m}_{i}} + {e}_{RX , i}^{{k}_{i}} ) + ( {T}_{UE , i} + {e}_{TX , i}^{{l}_{i}} + {e}_{RX , UE}^{{n}_{i}} )}{2} = {T}_{UE , i} + \frac{( {e}_{TX , i}^{{l}_{i}} - {e}_{RX , i}^{{k}_{i}} )}{2} + \frac{( {e}_{TX , UE}^{{m}_{i}} - {e}_{RX , UE}^{{n}_{i}} )}{2} = {T}_{UE , i} + \frac{{e}_{i}^{{l}_{i} , {k}_{i}}}{2} + \frac{{e}_{UE}^{{m}_{i} , {n}_{i}}}{2} , \qquad ( 27 )$$

where T_{UE,i} is the propagation time between a UE and the gNBi, e_{UE}^{m}^{ᵢ}^{,n}^{ᵢ} is the UE total (TX+RX) timing error for the mᵢ^{th} TX and nᵢ^{th} RX TEGs, and eᵢ^{l}^{ᵢ}^{,k}^{ᵢ} is the gNBi total (TX+RX) timing error for the lᵢ^{th} TX and kᵢ^{th} RX TEGs. The estimation accuracy of the Multi-RTT positioning method depends on total UE and gNB timing errors.

(c) Observation 3:

(c.1) The Multi-RTT positioning method timing error depends on both UE and gNB total (TX+RX) timing errors.

### Multi-RTT Time Difference Positioning Method

The Multi-RTT time difference positioning method performs the difference of Multi-RTT measurements (i.e. of mRTTⱼ and mRTTⱼ as defined in (27)):

$${mRTT}_{i , j} = {mRTT}_{i} - {mRTT}_{j} = ( {T}_{UE , i} - {T}_{UE , j} ) + \frac{{e}_{i}^{{l}_{i} , {k}_{i}} - {e}_{j}^{{l}_{j} , {k}_{j}}}{2} + \frac{{e}_{UE}^{{m}_{i} , {n}_{i}} - {e}_{UE}^{{m}_{j} , {n}_{j}}}{2} , \qquad ( 28 )$$

where (T_{UE,i}−T_{UE,j}) is the propagation time difference between a UE and the gNBi and gNBj and (eᵢ^{l}^{ᵢ}^{,k}^{ᵢ}−eⱼ^{l}^{ⱼ}^{,k}^{ⱼ}) is the total timing error difference of gNBi and gNBj, and (e_{UE}^{m}^{ᵢ}^{,n}^{ᵢ}−eⱼ^{m}^{ⱼ}^{,n}^{ⱼ}) is the total timing error difference for the (mᵢ, nᵢ)^{th} and (mⱼ, nⱼ)^{th} UE TEGs.

(d) Observation 4:

(d.1) The timing error for the multi-RTT time difference method depends on the gNB total (TX+RX) timing error difference.

(d.2) The timing error for the multi-RTT time difference method depends on the UE total (TX+RX) timing error difference if UE uses different TEGs for different gNBs/TRPs.

The disclosure herein below describes the estimation of TX/RX timing errors at the gNB and UE for timing-based NR positioning methods using estimations obtained with the reference device.

### Multi-TEG NB/TRP Calibration

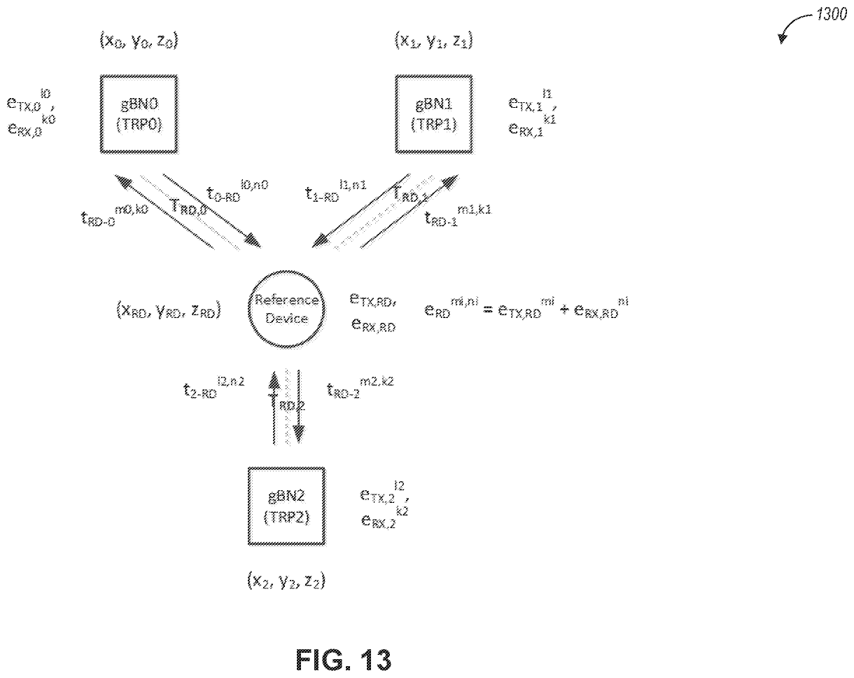

An example of three gNBs (or TRPs) with known coordinates (xᵢ, yᵢ, zᵢ) is shown in FIG. 13, where each gNBi has an internal TX timing error—eTX,ili for the lᵢ^{th} TEG and RX timing error—e_{RX,i}^{k}^{ᵢ} for the kᵢ^{th} TEG.

FIG. 13 illustrates a diagram 1300 of an example of timing measurements between three gNBs/TRPs and Reference Device (RD) with a known location, according to some embodiments.

A Reference Device (RD), which is used to calibrate (estimate) the TX and RX TRP timing errors, is illustrated in FIG. 13.

The RD has known coordinates (x_{RD}, y_{RD}, z_{RD}) and may have its own non-zero internal TX timing error—e_{TX,RD}^{m}^{ᵢ} for the mith TEG (used for transmission to gNBi) and RX timing error—e_{RX,RD}ⁿ^{ᵢ} for the nᵢ^{th} TEG (used for reception from gNBi). The total TX+RX timing error of RD can be found as a sum of the TX and RX timing errors as e_{RD}^{m}^{ᵢ}^{,n}^{ᵢ}=e_{TX,RD}^{m}^{ᵢ}+e_{RX,RD}ⁿ^{ᵢ}.

First, the gNBi sends a reference signal to the RD, where the propagation time t_{i-RD}^{l}^{ᵢ}^{,n}^{ᵢ} can be represented in the form:

t_{i-RD}^{l}^{ᵢ}^{,n}^{ᵢ}=T_{RD,i}+e_{TX,i}^{l}^{ᵢ}+e_{RX,RD}ⁿ^{ᵢ}, (29)

where T_{RD,i} is the known propagation time (calculated based on the known gNBi and RD coordinates), e_{TX,i}^{l}^{ᵢ} is the gNBi TX timing error for the lᵢ^{th} TEG, and e_{RX,RD}ⁿ^{ᵢ} is the RD RX timing error for the nᵢ^{th} TEG.

Second, they interchange the roles and now the RD sends a reference signal to the gNBi, where the propagation time t_{RD-i}^{m}^{ᵢ}^{,k}^{ᵢ}, can be represented in the form:

t_{RD-i}^{m}^{ᵢ}^{,k}^{ᵢ}=T_{RD,i}+e_{TX,RD}^{m}^{ᵢ}+e_{RX,i}^{k}^{ᵢ}, (30)

where T_{RD,i} is the known propagation time (calculated based on the known gNBi and RD coordinates), e_{TX,RD}^{m}^{ᵢ} is the RD TX timing error for the mith TEG, and e_{RX,i}^{k}^{ᵢ} is the gNBi RX timing error for the kᵢ^{th} TEG.

In (29) and (30), it may be assumed that the RD does not change the TX and RX TEGs, while performing measurements with the gNB0, gNB1, and gNB2. In that case, all equations will be affected by the same TX timing error e_{TX,RD}^{m}, and the same RX timing error e_{RX,RD}ⁿ, where indices (mi=m, ni=n) are constant and link independent.

If the timing errors e_{TX,RD}^{m} and e_{TX,RD}ⁿ are small enough or equal to zero, then the associated error with the RD transmission and reception can be neglected. In the general case, the RD may have some timing error margin.

The timing errors estimate for each timing-based positioning method, using the general equations defined in (29) and (30) is discussed below.

### Solution for DL-TDOA Positioning Method

For the DL-TDOA positioning method, the solution for each TX timing error difference (e_{TX,i}^{l}^{ᵢ}−e_{TX,j}^{l}^{ⱼ}) using (29) can be found in the form:

e_{TX,i}^{l}^{ᵢ}−e_{TX,j}^{l}^{ⱼ}=(t_{i-RD}^{l}^{ᵢ}^{,n}−t_{j-RD}^{l}^{ⱼ}^{,n})−(t_{RD,i}−T_{RD,j}). (31)

(e) Observation 5:

(e.1) If the reference device uses the same RX TEGs for the reception with different gNBs/TRPs, then the gNBs/TRPs TX timing error difference can be estimated with no impact from the timing errors of the reference device.

Solution for UL-TDOA Positioning Method

For the UL-TDOA positioning method, the solution for each RX timing error difference (e_{RX,i}^{k}^{ᵢ}−e_{RX,j}^{k}^{ⱼ}) using (30) can be found in the form:

e_{RX,i}^{k}^{ᵢ}−e_{RX,j}^{k}^{ⱼ}=(t_{RD-i}^{m,k}^{ᵢ}−t_{RD-j}^{m,k}^{ⱼ})−(T_{RD-i}−T_{RD,j}). (32)

(f) Observation 6:

(f.1) If the reference device uses the same TX TEGs for transmission with different gNBs/TRPs, then the gNBs/TRPs RX timing error difference can be estimated with no impact from the timing errors of the reference device.

### Solution for Multi-RTT Positioning Method

For the Multi-RTT positioning method, the solution for the common timing error using (29) and (30) can be found in the form:

eᵢ^{l}^{ᵢ}^{,k}^{ᵢ}=(t_{i-RD}^{l}^{ᵢ}^{,n}+t_{RD-i}^{m,k}^{ᵢ})−2T_{RD,i}−e_{RD}^{m,n}. (33)

(g) Observation 7:

(g.1) If the reference device uses the same TX and RX TEGs for transmission and reception with different gNBs/TRPs, then the estimated gNBs/TRPs total timing errors will have the same bias (identical for all gNBs/TRPs) equal to the total timing error of the reference device.

(g.2) This bias can be neglected, if the total timing error of the reference device is small enough compared to other gNB/TRP/UE errors and meets a certain error margin requirement.

### Solution for Multi-RTT Time Difference Positioning Method

For the Multi-RTT time difference method, the solution for the common timing error difference using (33) can be found in the form:

eᵢ^{l}^{ᵢ}^{,k}^{ᵢ}−eⱼ^{l}^{ⱼ}^{,k}^{ⱼ}=(t_{i-RD}^{l}^{ᵢ}^{,n}+t_{RD-i}^{m,k}^{ᵢ})−(t_{j-RD}^{l}^{ᵢ}^{,n}+t_{RD-j}^{m,k}^{ᵢ})−2(T_{RD,i}−T_{RD,j}). (34)

(h) Observation 8:

(h.1) If the reference device uses the same TX and RX TEGs for transmission and reception with different gNBs/TRPs, then the gNBs/TRPs total timing error difference can be estimated with no impact from the timing errors of the reference device.

### Impact of NLOS Excess Propagation Delay

The multi-TEG gNB/TRP calibration procedure described above is performed in the assumption that all links are the LOS links (i.e. LOS centric calibration solution). If one of the used TX/RX links in the calibration procedure is an NLOS link, then in addition to the timing errors (related to implementation), it might introduce an excess propagation delay caused by the NLOS propagation phenomenon.

This issue is specifically important if the reference device is defined as a reference UE. In that case, it may be located at a lower height (compared to the gNB/TRP) and therefore experience an NLOS propagation.

To avoid the NLOS excess propagation delay estimation during calibration procedure and introduction of additional bias into the timing error estimate, the reference device needs to inform gNB/TRP and/or LMF, that the used link is essentially an NLOS link.

In some embodiments, a reference device can report to the gNB/LMF its error margin per TEG if it uses multiple TEGs for transmission and reception. If the error estimate between the measured propagation time and the reference time derived from the known RD and gNB/TRP coordinates exceeds the reported error margin, then it might be an indication that the link is an NLOS link.

Based on the above considerations, the following proposals can be considered in example embodiments:

(a) Proposal 1:

(a.1) Support solution where reference device is a reference UE with known coordinates and a certain timing error margin specified for each TEG if reference UE uses multiple TEGs for signals transmission and reception.

(a.2) The solution with a reference UE may benefit from reusing the UL SRS and DL PRS structure, already defined in the specification.

In some embodiments, a reference device can report the LOS/NLOS type of the link explicitly, based on some a priori information (obtained from the reference device installation) or estimated using characteristics of the signal (for example channel impulse response measurements). It may potentially avoid the issue when the excess delay is smaller than the reported error margin, but the considered link is still an NLOS link.

The reported metric in that case can be defined as a variable distributed in the range from 0 to 1, where 0 indicates a pure LOS channel and 1 indicates a pure NLOS channel or vice versa. The absolute value of the reported metric indicates the reliability of the decision.

In case, if the gNB/TRP is considered as a reference device, then a calibration procedure may be used and the reporting of the timing measurements can be supported from gNB/TRP to LMF, if necessary.

(b) Proposal 2: Specify reporting format of reference device coordinates from a reference device to LMF/gNB.

(c) Proposal 3: Specify reporting format of reference device timing error margin per TEG (if it uses multiple TEGs for transmission and reception) from a reference UE to LMF/gNB.

(d) Proposal 4:

(d.1) Support TX/RX timing errors measurement report signaling from gNB/TRP to LMF and/or reference device to LMF, including the following information/measurements:

(d.1.1) For the DL-TDOA positioning method, report time difference value (RSTD) (t_{i-RD}^{l}^{ᵢ}^{,n}−t_{j-RD}^{l}^{ⱼ}^{,n}) between the i^{th} gNB/TRP with the lᵢ^{th} TX TEG and the reference device with the n^{th} RX TEG and the j^{th} gNB/TRP with the lⱼ^{th} TX TEG and the reference device with the nth RX TEG.

(d.1.2) For the UL-TDOA positioning method, report time difference value (RTOA) (t_{RD-i}^{m,k}^{ᵢ}−t_{RD-j}^{m,k}^{ⱼ}) between the reference device with the m^{th} TX TEG and the i^{th} gNB/TRP with the kᵢ^{th} RX TEG and the reference device with the m^{th} TX TEG and the j^{th} gNB/TRP with the kⱼ^{th} RX TEG.

(d.1.3) For the Multi-RTT positioning method, report RX-TX time difference for the i^{th} gNB with the lᵢ^{th} TX TEG and the kᵢ^{th} RX TEG and the RX-TX time difference for the reference device with the m^{th} TX TEG and the nth RX TEG.

(e) Proposal 5: Support introduction of gNB/TRP TX TEG ID associated with the DL PRS Resource ID (or multiple IDs) and/or DL PRS Resource Set ID (or multiple IDs).

(f) Proposal 6: Support introduction of UE TX TEG ID associated with the SRS Resource ID (or multiple IDs) and/or SRS Resource Set ID (or multiple IDs).

(g) Proposal 7:

(g.1) Support introduction of TX/RX TEG IDs associated with the measurement using the following format:

(g.1.1) (TRP TX TEG ID #1, TRP TX TEG ID #2, UE RX TEG ID #1, UE RX TEG ID #2)—associated with the RSTD measurement. Note: TRP TX TEG ID #1 and TRP TX TEG ID #2 reporting may not be needed, if association with the DL PRS Resources is introduced.

(g.1.2) (UE TX TEG ID #1, UE TX TEG ID #2, TRP RX TEG ID #1, TRP RX TEG ID #2)—associated with the RTOA measurement. Note: UE TX TEG ID #1 and UE TX TEG ID #2 reporting may not be needed, if association with the UL SRS Resources is introduced.

(g.1.3) (TRP TX TEG ID, UE RX TEG ID), (UE TX TEG ID, TRP RX TEG ID)—associated with the RX-TX time difference measurement. Note: TRP TX TEG ID and UE TX TEG ID reporting may not be needed if association with the DL PRS Resource and UL SRS Resource is introduced.

(h) Proposal 8:

(h.1) Support introduction of TX/RX TEG IDs associated with the measurement using the following format:

(h.1.1) (UE RX TEG ID #1, UE RX TEG ID #2)—associated with the RSTD measurement.

(h.1.2) (TRP RX TEG ID #1, TRP RX TEG ID #2)—associated with the RTOA measurement.

(h.1.3) (UE RX TEG ID), (TRP RX TEG ID)—associated with the RX-TX time difference measurement.

### Multi-TEG UE Calibration

An example of UE performing timing measurements with the i^{th} gNB/TRP using multiple TEGs is shown in FIG. 12. The UE has an internal TX timing error—e_{TX,UE}^{m}^{ᵢ} for the mᵢ^{th} TEG, and RX timing error—e_{RX,UE}ⁿ^{ᵢ} for the nᵢ^{th} TEG. The total TX+RX timing error of UE can be found as a sum of the TX and RX timing errors as e_{UE}^{m}^{ᵢ}^{,n}^{ᵢ}=e_{TX,UE}^{m}^{ᵢ}+e_{RX,UE}ⁿ^{ᵢ}.

### Solution for DL-TDOA Positioning Method

For the DL-TDOA positioning method, the RX timing error difference (e_{RX,UE}ⁿ^{ᵢ}−e_{RX,UE}ⁿ^{ⱼ}) of the nᵢ^{th} and nⱼ^{th} UE TEGs need to be estimated. It can be done by subtracting two propagation time equations with the iith gNB/TRP TX TEG and two nᵢ^{th} and nⱼ^{th} UE RX TEGs:

e_{TX,i}^{l}^{ᵢ}+T_{UE,i}+e_{RX,UE}ⁿ^{ᵢ}=t_{i-UE}^{l}^{ᵢ}^{,n}^{ᵢ}

e_{TX,i}^{l}^{ᵢ}+T_{UE,i}+e_{RX,UE}ⁿ^{ⱼ}=t_{i-UE}^{l}^{ᵢ}^{,n}^{ⱼ}. (35)

The estimated RX timing error difference (e_{RX,UE}ⁿ^{ᵢ}−e_{RX,UE}ⁿ^{ⱼ}) can be found as:

e_{RX,UE}ⁿ^{ᵢ}−e_{RX,UE}ⁿ^{ⱼ}=t_{i-UE}^{l}^{ᵢ}^{,n}^{ᵢ}−t_{i-UE}^{l}^{ᵢ}^{,n}^{ⱼ}, (36)

where t_{i-UE}^{l}^{ᵢ}^{,n}^{ᵢ} is the propagation time between the lᵢ^{th} TEG of gNB and the nith TEG of UE and t_{i-UE}^{l}^{ᵢ}^{,n}^{ⱼ} is the propagation time between the lᵢ^{th} TEG of gNB and the nⱼ^{th} TEG of UE.

(a) Observation 1: If the i^{th} gNB/TRP uses the same TX TEG for transmission with the different RX TEGs of the UE, then the UE RX timing error difference can be estimated with no impact from the timing errors of gNB/TRP.

### Solution for UL-TDOA Positioning Method

For the UL-TDOA positioning method, the TX timing error difference (e_{TX,UE}^{m}^{ᵢ}−e_{TX,UE}^{m}^{ⱼ}) of the mᵢ^{th} and mⱼ^{th} UE TEGs need to be estimated. It can be done by subtracting two measurements performed with the ith gNB/TRP RX TEG and two nᵢ^{th} and nⱼ^{th} UE RX TEGs:

e_{TX,UE}^{m}^{ᵢ}+T_{UE,i}+e_{RX,i}^{k}^{ᵢ}=t_{UE-i}^{m}^{ᵢ}^{,k}^{ᵢ}

e_{TX,UE}^{m}^{ⱼ}+T_{UE,i}+e_{RX,i}^{k}^{ᵢ}=t_{UE-i}^{m}^{ⱼ}^{,k}^{ᵢ}. (37)

The estimated total timing error difference (e_{TX,UE}^{m}^{ᵢ}−e_{TX,UE}^{m}^{ⱼ}) can be found as:

e_{TX,UE}^{m}^{ᵢ}−e_{TX,UE}^{m}^{ⱼ}=t_{UE-i}^{m}^{ᵢ}^{,k}^{ᵢ}−t_{UE-i}^{m}^{ⱼ}^{,k}^{ᵢ}. (37)

where t_{UE-i}^{m}^{ᵢ}^{,k}^{ᵢ} is the propagation time measured between the mᵢ^{th} TEG of UE and the kᵢ^{th} TEG of gNB and t_{UE-i}^{m}^{ⱼ}^{,k}^{ᵢ} is the propagation time measured between the mith TEG of UE and the kith TEG of gNB.

(b) Observation 2: If the i^{th} gNB/TRP uses the same RX TEG for the reception with the different TX TEGs of the UE, then the UE TX timing error difference can be estimated with no impact from the timing errors of gNB/TRP.

### Solution for Multi-RTT Time Difference Positioning Method

For the Multi-RTT time difference positioning method, the TX timing error difference (e_{TX,UE}^{m}^{ᵢ}−e_{TX,UE}^{m}^{ⱼ}) of the mᵢ^{th} and mⱼ^{th} UE TEGs in (38) can be summed up with the RX timing error difference (e_{TX,UE}ⁿ^{ᵢ}−e_{TX,UE}ⁿ^{ⱼ}) of the nᵢ^{th} and nⱼ^{th} UE TEGs in (36) to obtain the total timing error difference:

e_{TX,UE}^{m}^{ᵢ}−e_{TX,UE}^{m}^{ⱼ}=t_{UE-i}^{m}^{ᵢ}^{,k}^{ᵢ}−t_{UE-i}^{m}^{ⱼ}^{,k}^{ᵢ}

e_{TX,UE}ⁿ^{ᵢ}−e_{TX,UE}ⁿ^{ⱼ}=t_{i-UE}^{l}^{ᵢ}^{,n}^{ᵢ}−t_{i-UE}^{l}^{ᵢ}^{,n}^{ⱼ}, (39)

The estimated total timing error difference (e_{UE}^{m}^{ᵢ}^{,n}^{ᵢ}−e_{UE}^{m}^{ⱼ}^{,n}^{ⱼ} can be found as:

e_{UE}^{m}^{ᵢ}^{,n}^{ᵢ}−e_{UE}^{m}^{ⱼ}^{,n}^{ⱼ}=(t_{UE-i}^{m}^{ᵢ}^{,k}^{ᵢ}+t_{i-UE}^{l}^{ᵢ}^{,n}^{ᵢ})−(t_{UE-i}^{m}^{ⱼ}^{,k}^{ᵢ}+t_{i-UE}^{l}^{ᵢ}^{,n}^{ⱼ}), (40)

where t_{UE-i}^{m}^{ᵢ}^{,k}^{ᵢ} is the propagation time measured between the mith TEG of UE and the kᵢ^{th} TEG of gNB, t_{UE-i}^{m}^{ⱼ}^{,k}^{ᵢ} is the propagation time measured between the mjth TEG of UE and the kith TEG of gNB, t_{i-UE}^{l}^{ᵢ}^{,n}^{ᵢ}, is the propagation time measured between the lith TEG of gNB and the nith TEG of UE, and t_{i-UE}^{l}^{ᵢ}^{,n}^{ⱼ} is the propagation time measured between the lith TEG of gNB and the njth TEG of UE.

(c) Observation 3: If the i^{th} gNB/TRP uses the same TX and RX TEGs for transmission and reception with different TX and RX TEGs of the UE, then the UE total timing error difference can be estimated with no impact from the timing errors of the ith gNB/TRP.

### Solution for Multi-RTT Positioning Method

For the Multi-RTT positioning method, one of the TX and RX TEGs can be considered as a reference. Without loss of generality, let's assume that the reference TEG has TX and RX indexes (r, v). In that case, a total timing error with indexes (mᵢ, nᵢ)≠(r, v) can be represented using error e_{UE}^{r,v}, and (40) as follows:

e_{UE}^{m}^{ᵢ}^{,n}^{ᵢ}=(t_{UE-i}^{m}^{ᵢ}^{,k}^{ᵢ}+t_{i-UE}^{l}^{ᵢ}^{,n}^{ᵢ})−(t_{UE-i}^{r,k}^{ᵢ}+t_{i-UE}^{l}^{ᵢ}^{,v})+e_{UE}^{r,v}. (41)

Substituting (33) and (41) into (27) results in the following:

$${mRTT}_{i} = {T}_{UE , i} - \frac{( {t}_{i - RD}^{{l}_{i} , n} + {t}_{RD - i}^{m , {k}_{i}} )}{2} + \frac{( {t}_{UE - i}^{{m}_{i} , {k}_{i}} + {t}_{i - UE}^{{l}_{i} , {n}_{i}} ) - ( {t}_{UE - i}^{r , {k}_{i}} + {t}_{i - UE}^{{l}_{i} , v} )}{2} + \frac{{e}_{UE}^{r , v} - {e}_{RD}^{m , n}}{2} . \qquad ( 42 )$$

If the i^{th} Multi-RTT measurement is corrected as follows:

$${mRTT}_{i}^{′} = {mRTT}_{i} - \frac{( {t}_{i - RD}^{{l}_{i} , n} + {t}_{RD - i}^{m , {k}_{i}} )}{2} + \frac{( {t}_{UE - i}^{{m}_{i} , {k}_{i}} + {t}_{i - UE}^{{l}_{i} , {n}_{i}} ) - ( {t}_{UE - i}^{r , {k}_{i}} + {t}_{i - UE}^{{l}_{i} , v} )}{2} , \qquad ( 43 )$$

then the corrected value can be represented as:

$${mRTT}_{i}^{′} = {T}_{UE , i} + \frac{{e}_{UE}^{r , v} - {e}_{RD}^{m , n}}{2} . \qquad ( 44 )$$

As follows from (44), all measurements have the same bias, equal to:

$$bias = \frac{{e}_{UE}^{r , v} - {e}_{RD}^{m , n}}{2} . \qquad ( 45 )$$

The common bias can be estimated using the following two-stage procedure.

### Two-Stage Procedure for Bias Compensation

At the first stage, a Multi-RTT time difference method may be applied to estimate the UE coordinates. Using found UE coordinates, it is possible to estimate the distance and thus the corresponding propagation time T_{UE,i}′ from UE to gNBi.

Then the bias in (44) can be estimated by averaging the time difference observations over different gNBs/TRPs:

$$bias = \frac{1}{N} {\sum }_{i = 0}^{N - 1} ( {mRTT}_{i}^{′} - {T}_{UE , i}^{′} ) , \qquad ( 46 )$$

where mRTTᵢ′ is introduced as defined in (44) and N denotes the total number of links used in the estimation.

At the second stage, the estimated bias is used and is compensated in (44). Then the Multi-RTT positioning procedure can be executed again to enhance the performance accuracy of the Multi-RTT time difference method, applied at the first stage. The procedure can be iteratively repeated several times to improve the positioning accuracy.

(d) Observation 4: For the Multi-RTT positioning method after application of calibration procedure considered above, all round-trip measurements will be affected by the same bias, which is a difference of the total UE and reference device timing errors

Based on the above considerations the following techniques may be used:

(i) Proposal 9:

(i.1) Support TX/RX timing errors measurement report signaling from gNB/TRP to LMF and/or UE to LMF, including the following information/measurements:

(i.1.1) For the DL-TDOA positioning method, report time difference value (t_{i-UE}^{l}^{ᵢ}^{,n}^{ᵢ}−t_{i-UE}^{l}^{ᵢ}^{,n}^{ⱼ}) between the i^{th} gNB/TRP with the lᵢ^{th} TX TEG and the UE with the nith RX TEG and the i^{th} gNB/TRP with the lᵢ^{th} TX TEG and the UE with the nⱼ^{th} RX TEG.

(i.1.2) For the UL-TDOA positioning method, report time difference value (t_{i-UE}^{m}^{ᵢ}^{,k}^{ᵢ}−t_{i-UE}^{m}^{ⱼ}^{,k}^{ⱼ}) between the UE with the mᵢ^{th} TX TEG and the i^{th} gNB/TRP with the kᵢ^{th} RX TEG and the UE with the mⱼ^{th} TX TEG and the ith gNB/TRP with the kᵢ^{th} RX TEG.

(i.1.3) For the Multi-RTT positioning method, report RX-TX time difference for the i^{th} gNB with the lᵢ^{th} TX TEG and the kᵢ^{th} RX TEG and the RX-TX time difference for the UE with the mᵢ^{th} TX TEG and the nᵢ^{th} RX TEG.

### Proposed Measurement Report Types

To support measurement reporting with different TX and RX TEGs, the following measurement report types introduced below may be used.

The measurement report may be sent by a UE to a single serving gNB or a single serving gNBs and multiple neighbor gNBs (TRPs). The measurement report may be sent by a UE to the Location Management Function (LMF) entity. The measurement report may be sent by a serving gNB or a serving gNB and multiple neighbor gNBs (TRPs) to the LMF entity. The measurement report may be sent by a serving gNB or a serving gNB and multiple neighbor gNBs (TRPs) to the UE.

The measurement report may be sent by an LMF entity to a serving gNB or a serving gNB and multiple neighbor gNBs (TRPs). The measurement report may be sent by an LMF entity to a UE. The measurement report may be sent by a serving gNB or a serving gNB and multiple neighbor gNBs (TRPs) to a UE.

Association of TEG with Positioning Measurements

Specific gNB/TRP Tx TEG is associated with DL PRS Resource ID (or multiple IDs) or DL PRS Resource SET ID (or multiple IDs). Specific UE Tx TEG is associated with SRS for Positioning Resource ID (or multiple IDs) or SRS for Positioning Resource Set ID (or multiple IDs).

In some embodiments, the DL-RSTD measurement is reported to have at least one or a combination of the following associated TEG indexes: Tx TEG index on ith gNB/TRP used for transmission of DL PRS signal; Tx TEG index on jth gNB/TRP used for transmission of DL PRS signal; UE Rx TEG index used for reception of DL PRS signal from ith gNB/TRP; and UE Rx TEG index used for reception of DL PRS from jth gNB/TRP.

In some embodiments, the UL-RSTD measurement is reported with at least one or a combination of the following associated TEG indexes: Tx TEG index of UE used for SRS for positioning transmission received by ith gNB/TPR; Tx TEG index of UE used for SRS for positioning transmission received by jth gNB/TPR; Rx TEG index of ith gNB/TRP used for SRS for positioning reception; and Rx TEG index for jth gNB/TRP used for SRS for positioning reception.

In some aspects, the multi-RTT measurement is reported with at least one or a combination of the following associated TEG indexes: UE Tx TEG index used for transmission of SRS for positioning; UE Rx TEG index used for reception of DL PRS from gNB/TRP; gNB/TRP Tx TEG index used for transmission of DL PRS signal; and Rx TEG index of gNB/TRP used for SRS for positioning reception.

### Positioning Measurement Reports

To support the proposed method in the standard, the following reports specified below may be used.

The measurement report may be sent by a UE to a single serving gNB or a single serving gNBs and multiple neighbor gNBs (TRPs). The measurement report may be sent by a UE to the Location Management Function (LMF) entity. The measurement report may be sent by a serving gNB or a serving gNB and multiple neighbor gNBs (TRPs) to the LMF entity. The measurement report may be sent by a serving gNB or a serving gNB and multiple neighbor gNBs (TRPs) to the UE.

The measurement report may be sent by an LMF entity to a serving gNB or a serving gNB and multiple neighbor gNBs (TRPs). The measurement report may be sent by an LMF entity to a UE. The measurement report may be sent by a serving gNB or a serving gNB and multiple neighbor gNBs (TRPs) to a UE.

### Additional Measurement Report—Type 1

The additional measurement report of type 1 contains Information Element (IE) NR-RelayPropagationTime with the fields specified below. The IE NR-RelayPropagationTime is used by the target device to provide information about actual measured trip time between any two gNB/TRPs using a Reference Device as a relay node (a gNB/TRP is used as a reference device). At least the following additional information is provided in the NR-RelayPropagationTime measurement report: Index of transmission node; Index of reception node; Index of node used as a relaying; Measurement quality value; Tx TEG index of the Transmitter node; Rx TEG index of the Receiver node; and Tx and Rx TEG indexes of the relaying node.

### Additional Measurement Report—Type 2

The additional measurement report of type 2 contains Information Element (IE) NR-RoundTripTime with the fields specified below. The IE NR-RoundTripTime is used by the target device to provide information about actual measured round trip time between any two nodes in the network (node type used for this measurement could be TRP or UE). At least the following additional information is provided in the NR-RoundTripTime measurement report: Index of the first node involved in measurement; Index of the second node involved into measurement; Measurement quality value; Tx and Rx TEG indexes of the first node; and Tx and Rx TEG indexes of the second node.

### Additional Measurement Report—Type 3

The additional measurement report of type 3 contains Information Element (IE) NR-PropagationTime with the fields specified below. The IE NR-PropagationTime is used by the target device to provide information about the actual measured propagation time between any two gNB/TRPs in the network. At least the following additional information is provided in the NR-PropagationTime measurement report: Index of transmitter node; Index of receiver node; Measurement quality value; Tx TEG index of the Transmitter node; and Rx TEG index of the Receiver node.

Extension of the Measurement Report Between gNB/TRP and UE

Following extensions for measurements between gNB/TRP and a UE should be done to support the calibration procedure described above. The term UE below can be treated as a reference device in case if the location of the node is known.

For the DL-TDOA positioning method, the report of time difference value (t_{i-UE}^{l}^{ᵢ}^{,n}^{ᵢ}−t_{i-UE}^{l}^{ᵢ}^{,n}^{ⱼ}) between the i^{th} gNB/TRP with the lᵢ^{th} TX TEG and the UE node with the nᵢ^{th} RX TEG and the ith gNB/TRP with the lᵢ^{th} TX TEG and the UE with the nᵢ^{th} RX TEG should be provided with at least one or a combination of following information fields: Tx TEG index of the i^{th} gNB/TRP; Tx TEG index of the jth gNB/TRP; UE Rx TEG index used for reception of DL PRS from i^{th} gNB/TRP; and UE Rx TEG index used for reception of DL PRS from j^{th} gNB/TRP.

For the UL-TDOA positioning method, the report of time difference value (t_{UE-i}^{m}^{ᵢ}^{,k}^{ᵢ}−t_{UE-i}^{m}^{ⱼ}^{,k}^{ⱼ}) between the UE with the mᵢ^{th} TX TEG and the i^{th} gNB/TRP with the kᵢ^{th} RX TEG and the UE with the mⱼ^{th} TX TEG and the ith gNB/TRP with the kⱼ^{th} RX TEG should be provided with at least one or a combination of following information fields: Tx TEG index of the the i^{th} gNB/TRP; Tx TEG index of the the j^{th} gNB/TRP; UE Rx TEG index used for reception of DL PRS from i^{th} gNB/TRP; UE Rx TEG index used for reception of DL PRS from j^{th} gNB/TRP.

For the Multi-RTT positioning method, the report of RX-TX time difference for the i^{th} gNB with the lᵢ^{th} TX TEG and the kᵢ^{th} RX TEG and the RX-TX time difference for the UE with the mᵢ^{th} TX TEG and the nith RX TEG should be provided with at least one or a combination of following information fields: Tx TEG index of the the gNB/TRP; Rx TEG index of the the gNB/TRP; UE Tx TEG index; and UE Rx TEG index.

### Reference Device Report

A UE or a TRP/gNB can be used as a reference device in the system in case if the location of the node is known. The reference device may be used to provide its position information using at least one or a combination of the following fields: node coordinate in absolute coordinates or relative to the known reference point; coordinate estimation accuracy or reporting accuracy margin; Tx/Rx timing error values for each TEG; and Tx/Rx timing error accuracy values for each TEG.

As an example, following Information Element (IE) in Table 5 can be used for coordinate reporting from reference device:

TABLE 5
CommonIEsProvideLocationInformation ::= SEQUENCE {

| | |
|---|---|
| locationEstimate | LocationCoordinates |
| OPTIONAL, | |
| locationError | LocationError |
| OPTIONAL, | |
| timingEstimate | Timing |
| OPTIONAL, | |
| timingErrorEstimate | TimingError |
| OPTIONAL, | |
| } | |
| LocationCoordinates ::= CHOICE { | |
| ellipsoidPoint Ellipsoid-Point, | |
| ellipsoidPointWithUncertaintyCircle | Ellipsoid- |
| PointWithUncertaintyCircle, | |
| ellipsoidPointWithUncertaintyEllipse | Ellipsoid- |
| PointWithUncertaintyEllipse, | |
| polygon | Polygon, |
| ellipsoidPointWithAltitude | EllipsoidPointWithAltitude, |

ellipsoidPointWithAltitudeAndUncertaintyEllipsoid

| | |
|---|---|
| | EllipsoidPointWithAllitudeAndU |
| | ncertaintyEllipsoid, |
| ellipsoidArc | ElllipsoidAre, |

```
    ...,
    highAccuracyEllipsoidPointWithUncertaintyEllipse-v1510
    HighAccuracyEllipsoidPointWithUncertaintyEllipse-r15,
    highAccuracyEllipsoidPointWithAltitudeAndUncertaintyEllipsoid-
    v1510
    HighAccuracyEllipsoidPointWithAltitudeAndUncertaintyEllipsoid-
    r15
}
...
```

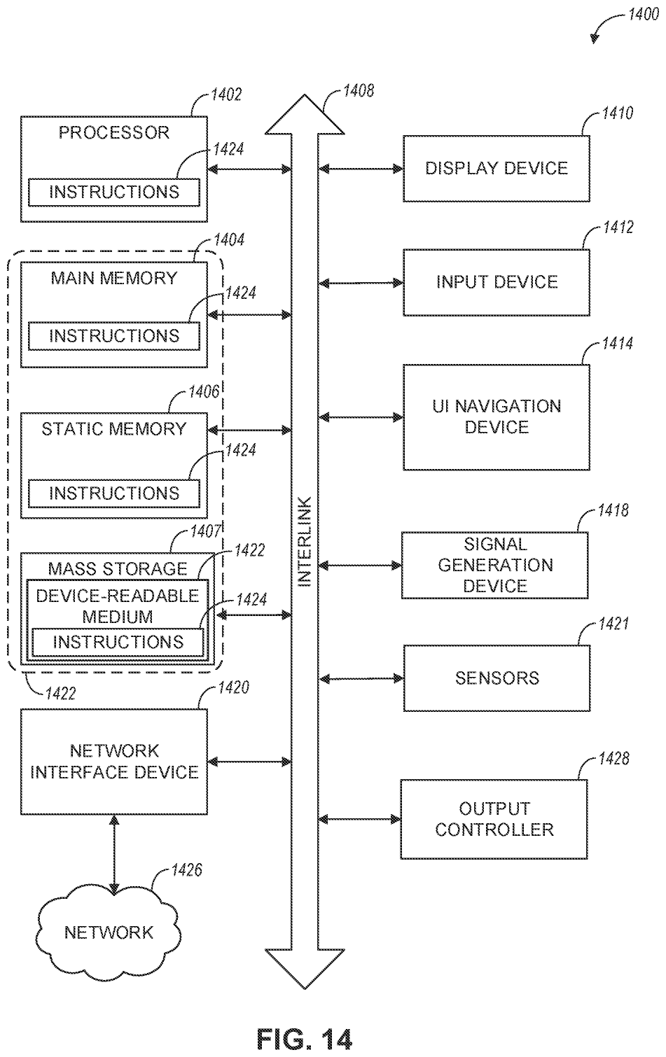

FIG. 14 illustrates a block diagram of a communication device such as an evolved Node-B (eNB), a new generation Node-B (gNB) (or another RAN node), an access point (AP), a wireless station (STA), a mobile station (MS), or a user equipment (UE), in accordance with some aspects and to perform one or more of the techniques disclosed herein. In alternative aspects, the communication device 1400 may operate as a standalone device or may be connected (e.g., networked) to other communication devices.

Circuitry (e.g., processing circuitry) is a collection of circuits implemented in tangible entities of the device 1400 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 1400 follow.

In some aspects, the device 1400 may operate as a standalone device or may be connected (e.g., networked) to other devices. In a networked deployment, the communication device 1400 may operate in the capacity of a server communication device, a client communication device, or both in server-client network environments. In an example, the communication device 1400 may act as a peer communication device in a peer-to-peer (P2P) (or other distributed) network environment. The communication device 1400 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 1400 may include a hardware processor 1402 (e.g., a central processing unit (CPU), a graphics processing unit (GPU), a hardware processor core, or any combination thereof), a main memory 1404, a static memory 1406, and a storage device 1407 (e.g., hard drive, tape drive, flash storage, or other block or storage devices), some or all of which may communicate with each other via an interlink (e.g., bus) 1408.

The communication device 1400 may further include a display device 1410, an alphanumeric input device 1412 (e.g., a keyboard), and a user interface (UI) navigation device 1414 (e.g., a mouse). In an example, the display device 1410, input device 1412, and UI navigation device 1414 may be a touchscreen display. The communication device 1400 may additionally include a signal generation device 1418 (e.g., a speaker), a network interface device 1420, and one or more sensors 1421, such as a global positioning system (GPS) sensor, compass, accelerometer, or another sensor. The communication device 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1407 may include a communication device-readable medium 1422, on which is stored one or more sets of data structures or instructions 1424 (e.g., software) embodying or utilized by any one or more of the techniques or functions described herein. In some aspects, registers of the processor 1402, the main memory 1404, the static memory 1406, and/or the storage device 1407 may be, or include (completely or at least partially), the device-readable medium 1422, on which is stored the one or more sets of data structures or instructions 1424, embodying or utilized by any one or more of the techniques or functions described herein. In an example, one or any combination of the hardware processor 1402, the main memory 1404, the static memory 1406, or the mass storage 1416 may constitute the device-readable medium 1422.

As used herein, the term “device-readable medium” is interchangeable with “computer-readable medium” or “machine-readable medium”. While the communication device-readable medium 1422 is illustrated as a single medium, the term “communication device-readable medium” may include a single medium or multiple media (e.g., a centralized or distributed database, and/or associated caches and servers) configured to store the one or more instructions 1424. The term “communication device-readable medium” is inclusive of the terms “machine-readable medium” or “computer-readable medium”, and may include any medium that is capable of storing, encoding, or carrying instructions (e.g., instructions 1424) for execution by the communication device 1400 and that causes the communication device 1400 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 1424 may further be transmitted or received over a communications network 1426 using a transmission medium via the network interface device 1420 utilizing any one of a number of transfer protocols. In an example, the network interface device 1420 may include one or more physical jacks (e.g., Ethernet, coaxial, or phone jacks) or one or more antennas to connect to the communications network 1426. In an example, the network interface device 1420 may include a plurality of antennas to wirelessly communicate using at least one of single-input-multiple-output (SIMO), MIMO, or multiple-input-single-output (MISO) techniques. In some examples, the network interface device 1420 may wirelessly communicate using Multiple User MIMO techniques.

The term “transmission medium” shall be taken to include any intangible medium that is capable of storing, encoding, or carrying instructions for execution by the communication device 1400, and includes digital or analog communications signals or another intangible medium to facilitate communication of such software. In this regard, a transmission medium in the context of this disclosure is a device-readable medium.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus for a location management function (LMF) node configured for operation in a Fifth Generation New Radio (5G NR) network, the apparatus comprising:
processing circuitry, wherein to configure the LMF node for user equipment (UE) location determination in the 5G NR network, the processing circuitry is to:
decode a measurement report message from a first Next Generation Node-B (gNBi), the measurement report message indicating a time difference (Δtij) between an actual measured propagation time delay (tij) and a reference propagation time delay (Tij) between the gNBi and at least a second gNB (gNBj) in the 5G NR network;
determine an error vector of internal transmit (Tx) errors and internal receive (Rx) errors for the gNBi and the gNBj based on the time difference;
decode a measurement response from the gNBi, the measurement response based on uplink (UL) sounding reference signal (SRS) transmitted by the UE and received at the gNBi;
perform an estimation of the UE location based on the measurement response; and
adjust the estimation of the UE location based on the determined error vector; and
a memory coupled to the processing circuitry and configured to store the measurement report message.

2. The apparatus of claim 1, wherein the measurement report message is an NR-Timing Error information element (IE).

3. The apparatus of claim 2, wherein the NR-Timing Error IE comprises an nr-relativeTimeDifference field including the time difference.

4. The apparatus of claim 2, wherein the NR-Timing Error IE comprises an nr-timing-Quality field indicating an estimate of measurement quality for the time difference.

5. The apparatus of claim 1, wherein the processing circuitry is configured to:
decode a second measurement report message from the gNBi, the second measurement report message indicating a total roundtrip time difference (Δtij+Δtji) between an actual measured propagation roundtrip time delay (tij+tji) and a reference propagation roundtrip time delay (2Tij) between the gNBi and the gNBj in the 5G NR network.

6. The apparatus of claim 5, wherein the processing circuitry is configured to:
determine a second error vector associated with sums of the internal Tx errors and the internal Rx errors for the gNBi and the gNBj based on the total roundtrip time difference.

7. The apparatus of claim 6, wherein the processing circuitry is configured to:
adjust the estimation of the UE location further based on the determined second error vector.

8. The apparatus of claim 1, wherein the processing circuitry is configured to:
decode a third measurement report message from the gNBi, the third measurement report message indicating a total timing error (e), the total timing error comprising a sum of Tx and Rx timing errors (e=eTX+eRX) for the gNBi; and
adjust the estimation of the UE location further based on the total timing error.

9. The apparatus of claim 1, further comprising transceiver circuitry coupled to the processing circuitry; and one or more antennas coupled to the transceiver circuitry.

10. A non-transitory computer-readable storage medium that stores instructions for execution by one or more processors of a location management function (LMF) node, the instructions to configure the LMF node for user equipment (UE) location determination in a Fifth Generation New Radio (5G NR) network and to cause the LMF node to perform operations comprising:
decoding a measurement report message from a first Next Generation Node-B (gNBi), the measurement report message indicating a time difference (Δtij) between an actual measured propagation time delay (tij) and a reference propagation time delay (Tij) between the gNBi and at least a second gNB (gNBj) in the 5G NR network;
determining an error vector of internal transmit (Tx) errors and internal receive (Rx) errors for the gNBi and the gNBj based on the time difference;
decoding a measurement response from the gNBi, the measurement response based on uplink (UL) sounding reference signal (SRS) transmitted by the UE and received at the gNBi;
performing an estimation of the UE location based on the measurement response; and
adjusting the estimation of the UE location based on the determined error vector.

11. The non-transitory computer-readable storage medium of claim 10, wherein the measurement report message is an NR-Timing Error information element (IE).

12. The non-transitory computer-readable storage medium of claim 11, wherein the NR-Timing Error IE comprises an nr-relativeTimeDifference field including the time difference.

13. The non-transitory computer-readable storage medium of claim 11, wherein the NR-Timing Error IE comprises an nr-timing-Quality field indicating an estimate of measurement quality for the time difference.

14. The non-transitory computer-readable storage medium of claim 10, the operations further comprising:
decoding a second measurement report message from the gNBi, the second measurement report message indicating a total roundtrip time difference (Δtij+Δtji) between an actual measured propagation roundtrip time delay (tij+tji) and a reference propagation roundtrip time delay (2Tij) between the gNBi and the gNBj in the 5G NR network.

15. The non-transitory computer-readable storage medium of claim 14, the operations further comprising:
determining a second error vector associated with sums of the internal Tx errors and the internal Rx errors for the gNBi and the gNBj based on the total roundtrip time difference.

16. The non-transitory computer-readable storage medium of claim 15, the operations further comprising:
adjusting the estimation of the UE location further based on the determined second error vector.

17. The non-transitory computer-readable storage medium of claim 10, the operations further comprising:
decoding a third measurement report message from the gNBi, the third measurement report message indicating a total timing error (e), the total timing error comprising a sum of Tx and Rx timing errors (e=eTX+eRX) for the gNBi; and
adjusting the estimation of the UE location further based on the total timing error.

18. A non-transitory computer-readable storage medium that stores instructions for execution by one or more processors of a location management function (LMF) node, the instructions to configure the LMF node for user equipment (UE) location determination in a Fifth Generation New Radio (5G NR) network and to cause the LMF node to perform operations comprising:
decoding a measurement report message from a first Next Generation Node-B (gNBi), the measurement report message indicating a time difference (Δtij) between an actual measured propagation time delay (tij) and a reference propagation time delay (Tij) between the gNBi and at least a second gNB (gNBj) in the 5G NR network;
decoding a second measurement report message from the gNBi, the second measurement report message indicating a total roundtrip time difference (Δtij+Δtji) between an actual measured propagation roundtrip time delay (tij+tji) and a reference propagation roundtrip time delay (2Tij) between the gNBi and the gNBj in the 5G NR network;
decoding a measurement response from the gNBi, the measurement response based on uplink (UL) sounding reference signal (SRS) transmitted by the UE and received at the gNBi;
performing an estimation of the UE location based on the measurement response; and
adjusting the estimation of the UE location based on the time difference and the total roundtrip time difference.

19. The non-transitory computer-readable storage medium of claim 18, the operations further comprising:
determining an error vector of internal transmit (Tx) errors and internal receive (Rx) errors for the gNBi and the gNBj based on the time difference; and
determining a second error vector associated with sums of the internal Tx errors and the internal Rx errors for the gNBi and the gNBj based on the total roundtrip time difference.

20. The non-transitory computer-readable storage medium of claim 19, the operations further comprising:
adjusting the estimation of the UE location further based on at least one of: the error vector and the second error vector.
